(19) United States
(12) Patent Application Publication
(10) Pub. No.: US 2026/0075651 A1
(43) Pub. Date: Mar. 12, 2026

(54) METHOD FOR COMMUNICATION, AND COMMUNICATION DEVICES

(71) Applicant: GUANGDONG OPPO MOBILE TELECOMMUNICATIONS CORP., LTD., Dongguan (CN)

(72) Inventors: Chaoming LUO, Dongguan (CN); Ning GAO, Dongguan (CN); Liuming LU, Dongguan (CN); Yapu LI, Dongguan (CN)

(21) Appl. No.: 19/394,375

(22) Filed: Nov. 19, 2025

Related U.S. Application Data
(63) Continuation of application No. PCT/CN2023/116102, filed on Aug. 31, 2023.

(51) Int. Cl. H04W 74/0816; H04W 74/00

(52) U.S. Cl. CPC H04W 74/0816; H04W 74/002

(57) ABSTRACT

Provided is a method for communication, and communication devices. The method includes: receiving, by a third access point (AP), a first frame from a second AP, wherein the first frame is used for the second AP to share a first transmission opportunity with the third AP, and the first frame is a request-to-send (RTS) frame or a multi-users request-to-send (MU-RTS) trigger frame; and performing, by the third AP, transmission within the first transmission opportunity.

### CROSS-REFERENCE TO RELATED APPLICATION

This application is a continuation application of international application No. PCT/CN2023/116102, filed on Aug. 31, 2023, the entire contents of which are incorporated herein by reference.

### TECHNICAL FIELD

The present disclosure relates to the field of communication technologies, and in particular, to a method for communication, and communication devices.

### RELATED ART

In an environment in which an overlapping basic service set (OBSS) exists, in order to, a coordinated time division multiple access (C-TDMA) technology is introduced in some practices to reduce a transmission delay of a basic service set (BSS) by sharing a transmission opportunity (TXOP) between access points (APs).

### SUMMARY

The present disclosure provides a method for communication, and communication devices. Various aspects of the present disclosure are described hereinafter.

In some embodiments of the present disclosure, a method for communication is provided. The method is performed by a first AP, and includes: receiving a first frame from a second AP, wherein the first frame is used for the second AP to share a first transmission opportunity with a third AP, and the first frame is a request-to-send (RTS) frame or a multi-users request-to-send (MU-RTS) trigger frame; and performing transmission within the first transmission opportunity.

In some embodiments of the present disclosure, a communication device is provided. The device includes: a memory and a processor, wherein the memory is configured to store one or more programs, and the processor is configured to call the one or more programs in the memory to cause the communication device to: receive a first frame from a second AP, wherein the first frame is used for the second AP to share a first transmission opportunity with a third AP, and the first frame is an RTS frame or a multi-users MU-RTS trigger frame; and perform transmission within the first transmission opportunity.

In some embodiments of the present disclosure, a communication device is provided. The device includes: a memory and a processor, wherein the memory is configured to store one or more programs, and the processor is configured to call the one or more programs in the memory to cause the communication device to: transmit a first frame to a first AP, wherein the first frame is used for the second AP to share a first transmission opportunity with a third AP, and the first frame is an RTS frame or a multi-users MU-RTS trigger frame, wherein the first transmission opportunity is used for transmission between the third AP and the first AP.

### BRIEF DESCRIPTION OF DRAWINGS

FIG. 1 is an exemplary diagram of a system architecture of a wireless communication system applicable to some embodiments of the present disclosure;

FIG. 2a is an exemplary diagram of an OBSS;

FIG. 2b is an exemplary diagram of the OBSS;

FIG. 3 is a schematic flowchart of a station accessing an AP based on an enhanced distributed channel access (EDCA) mechanism;

FIG. 4 is a schematic diagram of a backoff procedure of a station under an EDCA mechanism;

FIG. 5 is an exemplary diagram of adjusting an OBSS packet detect-based value and transmit power;

FIG. 6 is an exemplary diagram of a parameterized spatial reuse (PSR) mechanism;

FIG. 7 is an exemplary diagram of a process of a multi-AP coordinated measurement phase;

FIG. 8 is an exemplary diagram of a process of multi-AP coordinated measurement and coordinated transmission;

FIG. 9 is an exemplary diagram of a process of multi-AP coordinated transmission;

FIG. 10 is an exemplary diagram of a C-TDMA mechanism;

FIG. 11 is an exemplary diagram of an application scenario to which some embodiments of the present disclosure are applicable;

FIG. 12 is a schematic flowchart of a method for communication according to some embodiments of the present disclosure;

FIG. 13 is an exemplary diagram of a first frame according to some embodiments of the present disclosure;

FIG. 14 is a schematic flowchart of a method for communication according to some embodiments of the present disclosure;

FIG. 15 is a schematic flowchart of acquiring fourth information according to some embodiments of the present disclosure;

FIG. 16 is an exemplary diagram of a second frame according to some embodiments of the present disclosure;

FIG. 17 is an exemplary diagram of a response frame of a second frame according to some embodiments of the present disclosure;

FIG. 18 is an exemplary diagram of a process of multi-AP transmission according to some embodiments of the present disclosure;

FIG. 19 is an exemplary diagram of a process of multi-AP transmission according to some embodiments of the present disclosure;

FIG. 20 is an exemplary diagram of a process of multi-AP transmission according to some embodiments of the present disclosure;

FIG. 21 is an exemplary diagram of a process of multi-AP transmission according to some embodiments of the present disclosure;

FIG. 22 is an exemplary diagram of a process of multi-AP transmission according to some embodiments of the present disclosure;

FIG. 23 is a schematic structural diagram of an apparatus for communication according to some embodiments of the present disclosure;

FIG. 24 is a schematic structural diagram of an apparatus for communication according to some embodiments of the present disclosure;

FIG. 25 is a schematic structural diagram of an apparatus for communication according to some embodiments of the present disclosure; and

FIG. 26 is a schematic structural diagram of a communication device according to some embodiments of the present disclosure.

### DETAILED DESCRIPTION

The technical solutions according to the present disclosure will be described hereinafter with reference to the accompanying drawings.

### Communication System Architecture

The technical solutions according to the embodiments of the present disclosure are applicable to various communication systems, such as a wireless local area network (WLAN), wireless fidelity (Wi-Fi), or other communication systems. For example, the technical solutions according to the embodiments of the present disclosure are applicable to a communication system that adopts the 802.11 standard. Exemplarily, the 802.11 standard includes, but is not limited to, the 802.11ax standard, the 802.11be standard, the next-generation 802.11 standard, and the like.

The technical solutions according to the embodiments of the present disclosure are applicable to a plurality of scenarios, for example, communications between an AP and one or more stations (STAs), or communications between APs, or communications between STAs. In the embodiments of the present disclosure, the term “communication” is also understood as or replaced with other terms such as “transmission,” “data transmission,” or “information transmission.”

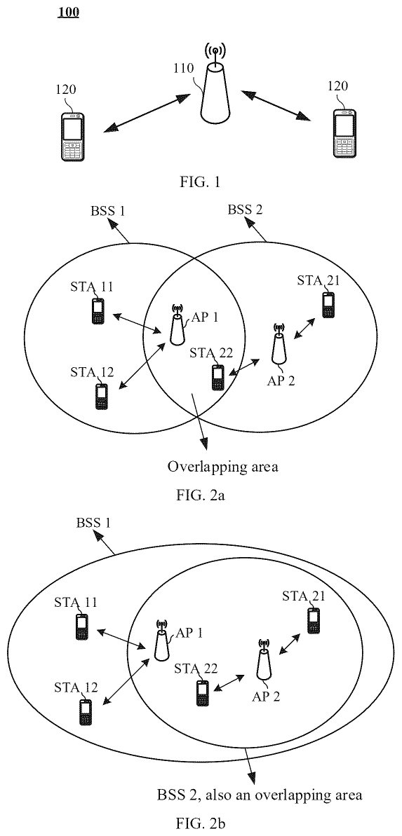

Referring to FIG. 1, FIG. 1 is an exemplary diagram of an architecture of a wireless communication system 100 applicable to the embodiments of the present disclosure. The wireless communication system 100 includes an AP 110 and STAs 120 that access a network through the AP 110.

In some scenarios, the AP is also referred to as an AP STA, which means that the AP is also a type of STA in some senses.

In some scenarios, the STA is also referred to as a non-AP STA.

The communications in the wireless communication system 100 are communications between an AP and an STA, or communications between STAs, or communications between an STA and a peer STA. The peer STA refers to a device in a peer communication with the STA. For example, the peer STA is an AP or an STA.

The AP involved in the embodiments of the present disclosure is an apparatus having a wireless communication function. In some embodiments, the AP supports a WLAN protocol for communication and has a function of communicating with other devices (such as other STAs or other APs) in the WLAN network.

The AP in the embodiments of the present disclosure is an apparatus that provides services for an STA. In some embodiments, the AP is a bridge to connect wired and wireless networks, and mainly functions to connect various wireless network clients and then access the wireless network to the Ethernet. The AP is a terminal device (such as a mobile phone) equipped with Wi-Fi chips or a network device (such as a router, a network bridge, or a switch). In addition, the embodiments of the present disclosure are not limited thereto. For example, the AP further includes various forms of macro base stations, micro base stations, relay stations, and the like.

The STA involved in the embodiments of the present disclosure is an apparatus having a wireless communication function. In some embodiments, the STA supports a WLAN protocol for communication and has a function of communicating with other STAs or APs in the WLAN network.

It should be understood that the role of the STA in the communication system is not absolute. For example, in some scenarios, the mobile phone is an STA in the case where the mobile phone connects to a router, and the mobile phone is an AP in the case where the mobile phone provides a hotspot for other devices.

Both the AP and the STA are devices applicable to the Internet of Vehicles, nodes and sensors in the Internet of Things (IoT), smart cameras, smart remote controls, smart water meters and electricity meters in smart homes, sensors in smart cities, or the like.

In some embodiments, both the STA and the AP support the 802.11be standard. The STA or the AP also supports various current and future WLAN standards of the 802.11 family, such as 802.11ax, 802.11ac, 802.11n, 802.11g, 802.11b, and 802.11a.

One or more links are present between the STA and the AP. In some embodiments, the STA and the AP support multi-frequency-band communications, for example, simultaneous communications at frequency bands of 2.4 GHz, 5 GHz, 6 GHz, 45 GHz, and 60 GHz, or simultaneous communications in different channels at a same frequency band (or different frequency bands), such that the communication throughput and/or reliability between devices are improved. Such device is often referred to as a multi-frequency-band device, or a multi-link device (MLD), and is sometimes also referred to as a multi-link entity or multi-frequency-band entity. The multi-link device is an AP MLD or an STA MLD. In the case where the multi-link device is an AP MLD, the multi-link device includes one or more APs; and in the case where the multi-link device is an STA MLD, the multi-link device includes one or more non-AP STAs.

The multi-link device including one or more APs is referred to as an AP MLD, and the MLD including one or more non-AP STAs is referred to as a Non-AP MLD.

In the embodiments of the present disclosure, the AP MLD includes a plurality of APs, the non-AP MLD includes a plurality of STAs, a plurality of links are formed between the APs in the AP MLD and the STAs in the non-AP MLD, and the communications between the APs in the AP MLD and the corresponding STAs in the non-AP MLD is performed over the corresponding links.

In the embodiments of the present disclosure, the STA is a device that supports WLAN/Wi-Fi technology, such as a mobile phone, a pad, a laptop computer, a pocket PC, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like.

Frequency bands supported by the WLAN technology include, but are not limited to, low frequency bands (e.g., 2.4 GHz, 5 GHz, and 6 GHz) and high frequency bands (e.g., 60 GHz).

FIG. 1 exemplarily shows an AP and two STAs. In some embodiments, the communication system 100 includes a plurality of APs and other numbers of STAs, which is not limited in the embodiments of the present disclosure.

It should be understood that a device having a communication function in the network/system according to some embodiments of the present disclosure is referred to as a communication device. Taking the communication system 100 shown in FIG. 1 as an example, the communication device includes an AP 110 and STAs 120 having a communication function, and the AP 110 and the STAs 120 are devices that have been specifically described above, which will not be repeated herein. The communication device further includes other devices in the communication system 100, such as other network entities, for example, a network controller, and a gateway, which are not limited in the embodiments of the present disclosure.

The AP and the STA are deployed on land, including indoor or outdoor, handheld or vehicle-mounted; or are also deployed on the water surface; or are also deployed on aerial airplanes, balloons, and satellites. The scenario in which the AP and the STA are located is not limited in the embodiments of the present disclosure.

It should be understood that all or some of the functions of the communication device in the present disclosure are also implemented using software functions running on hardware, or are implemented using virtualized functions instantiated on platforms (e.g., a cloud platform).

### OBSS

In some embodiments, the OBSS refers to a BSS operating on the same channel as the STA's BSS and within (either partly or wholly) its basic service area. The BSSs with such characteristics are OBSSs of each other. The basic service area (BSA) refers to the area containing the members of a BSS, and the BSA may contain members of other BSSs.

In other words, in the case where a basic service area of one BSS overlaps with a basic service area of another BSS, the two BSSs are OBSSs of each other. That is, the one BSS is referred to as an OBSS of the another BSS, and the another BSS is also referred to as an OBSS of the one BSS.

It should be understood that the overlapping described above refers to the case where a basic service area of one BSS partially is overlapped with a basic service area of another BSS, or refers to the case where an inclusion relationship (that is, a basic service area of one BSS falls within a basic service area of another BSS).

The OBSS is further described by taking the scenario shown in FIGS. 2a and 2b as an example. Taking FIG. 2a as an example, FIG. 2a is an exemplary diagram in which one BSS is overlapped with another BSS to form an OBSS. In FIG. 2a, AP 1, STA 11, and STA 12 belong to BSS 1, and both STA 11 and STA 12 are associated with AP 1; AP 2, STA 21, and STA 22 belong to BSS 2, and both STA 21 and the STA 22 are associated with AP 2. In FIG. 2a, a basic service area of BSS 1 is overlapped with a basic service area of BSS 2 (that is, an “overlapping area” in FIG. 2a). In this case, BSS 1 is referred to as an OBSS of BSS 2, and BSS 2 is also referred to as an OBSS of BSS 1. Taking FIG. 2b as an example, FIG. 2b is an exemplary diagram in which one BSS includes another BSS to form an OBSS. In FIG. 2b, AP 1, STA 11, and STA 12 belong to BSS 1, and both STA 11 and STA 12 are associated with AP 1; AP 2, STA 21, and STA 22 belong to BSS 2, and both STA 21 and STA 22 are associated with AP 2. In FIG. 2b, a basic service area of BSS 1 is overlapped with a basic service area of BSS 2 (that is, “BSS 2 is also an overlapping area” in FIG. 2b). In this case, BSS 1 is referred to as an OBSS of BSS 2, and BSS 2 is also referred to as an OBSS of BSS 1.

It should be noted that FIGS. 2a and 2b are described by taking two BSSs that are OBSSs of each other as an example. In practical applications, in the case where two or more BSSs (partly or wholly) are overlapped with each other, the two or more BSSs are also OBSSs of each other.

### EDCA

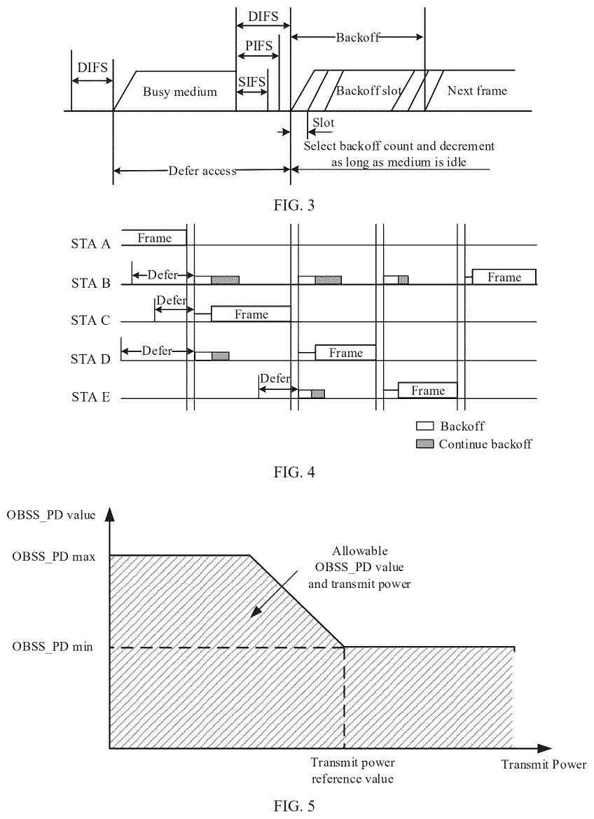

EDCA is a distributed channel access mechanism for Wi-Fi to achieve fair contention and priority scheduling between different types of applications. The EDCA is enhanced based on a distributed coordination function (DCF), and the EDCA mainly contends for a channel based on different access categories (ACs) using different interframe spaces (i.e., an arbitration interframe space (AIFS[AC])) and contention backoff windows (CW[AC]) for, and the DCF contends for a channel using a unified DCF interframe space (DIFS) and the contention backoff window. The following describes a process of an STA accessing an AP based on a DCF mechanism and a backoff procedure of the STA under the DCF mechanism with reference to FIGS. 3 and 4.

FIG. 3 shows a schematic flowchart of an STA accessing an AP based on a DCF mechanism. As shown in FIG. 3, in the case where the STA detects that a channel changes from busy to idle using a clear channel assessment (CCA, which may also be referred to as idle channel detection) mechanism, the STA needs to continue to detect that the channel remains idle within a distributed (coordination function) interframe space (DIFS); and then, in the case where a current random backoff counter value is 0, the STA acquires the channel access right, and may immediately perform transmission and reset the random backoff counter value. Otherwise, the STA needs to continue to detect whether the channel remains idle. In the case where the channel remains idle during each detection of the slot, the random backoff counter value of the station is decreased by 1, until the random backoff counter value of the station becomes 0. In this case, the station acquires the channel access right, and may immediately perform transmission and reset the random backoff counter value. Taking FIG. 3 as an example, in the case where the station detects that the channel is busy within a first DIFS, the station defers channel access; in the case where the station detects that the channel is idle within a second DIFS, but a current random backoff counter value of the station is not 0, the station needs to continue to detect whether the channel remains idle. In the case where the channel remains idle during each detection of the slot, the random backoff counter value of the station is decreased by 1, until the random backoff counter value of the station becomes 0. In this case, the station acquires the channel access right, and may immediately perform transmission and reset the random backoff counter value.

In some embodiments, in the detection process, since another station first acquires the channel access right through contention, the random backoff counter value of the station remains unchanged. In this way, next time the station detects that the channel changes from busy to idle through the CCA, the random backoff counter value of the station keeps the previous value.

FIG. 4 shows a schematic diagram of a backoff procedure of a station under a DCF mechanism. As shown in FIG. 4, in the case where station A occupies a channel for transmission, station B, station C, and station D detect that the channel is busy, and thus defer channel access. Then, in the case of detecting that the channel is idle, station B, station C, and station D contend for the channel access right. Assuming that station C acquires the channel access right through contention, station B and station D perform the backoff procedure to defer channel access. By analogy, stations contend for the channel access right under the DCF mechanism, or stations perform the backoff procedure to avoid transmission collisions in the case where another station acquires the channel access right through contention.

### RTS/Clear-To-Send (CTS)

In the BSS, an STA communicates with an AP, but the STA does not monitor other STAs or is not monitored by other STAs, resulting in a high probability of transmission collisions. In some implementations, the STA avoids a transmission collision through a monitoring mechanism. For example, in the case where the STA for monitoring monitors transmissions performed by another STA, the STA for monitoring sets a network allocation vector (NAV) timer for the transmission and monitors a radio frequency channel to avoid a collision with transmissions of the another STA. In some embodiments, the STA setting the NAV timer is considered as performing virtual carrier sense (CS). In some embodiments, the STA monitoring the radio frequency channel is considered as performing physical CS.

In some implementations, an RTS/CTS mechanism avoids a transmission collision by implementing NAV distribution. In the RTS/CTS mechanism, a transmission medium is reserved for a data frame prior to start of the transmission of the data frame by implementing NAV distribution. In some embodiments, the transmission medium is also understood as or replaced with a channel or a medium. The RTS/CTS mechanism is described in detail below.

In some embodiments, each time an STA using the RTS/CTS mechanism prepares to transmit a frame, the STA needs to perform RTS/CTS interaction prior to normal data transmission. Exemplarily, prior to transmission of a data frame by the STA, a transmitter first transmits an RTS frame, and all STAs for sensing reset their own NAV timer based on a value of a duration of the RTS frame, and wait for complete transmission of a CTS frame, the data frame, and an Ack frame. Then, a receiver transmits a CTS frame that is also used for NAV distribution, and all STAs for sensing reset the NAV timers based on a value of a duration of the CTS frame, and wait for complete transmission of the data frame and the Ack frame.

The value of the duration of the RTS frame and/or the CTS frame is not limited in the embodiments of the present disclosure. Exemplarily, the value of the duration of the RTS frame is a sum of a duration required for complete interaction of the CTS frame, the data frame, and the Ack frame, and three short interframe spaces (SIFSs). The value of the duration of the CTS frame is a sum of a duration required for complete interaction of the data frame and the Ack frame, and two SIFSs.

The unit of the duration of the RTS frame and/or the CTS frame is not limited in the embodiments of the present disclosure. Exemplarily, the duration of the RTS frame and/or the CTS frame is in units of microseconds, or is in units of other durations such as milliseconds or slots.

In some embodiments, even if the STA does not monitor the RTS frame, the STA should monitor the CTS frame. Regardless of which frame (an RTS frame or a CTS frame) the STA monitors, the STA sets the NAV timer based on the duration provided by the monitored frame. In this way, all STAs in the BSS set an NAV timer and wait for complete transmission of the entire data. In this way, a protection mechanism for avoiding a transmission collision is implemented.

However, the embodiments of the present disclosure are not limited to the use of the RTS/CTS mechanism to avoid a transmission collision. In some embodiments, a CTS-to-self mechanism is used to avoid a transmission collision. For example, in the case where different technologies exist in the same BSS, the CTS-to-self mechanism is used to avoid transmission collisions. Compared with the RTS/CTS mechanism, the advantages of the CTS-to-self mechanism as a protection mechanism to avoid transmission collisions are fewer transmitted frames and the improved throughput.

In some implementations, in the case of preparing to transmit data, the STA or the AP that uses the CTS-to-self performs NAV distribution by transmitting a CTS frame (a recipient address corresponding to the CTS frame is an address for transmitting the CTS frame, and therefore, the CTS frame is referred to as a CTS-to-self frame). In this case, the CTS frame (CTS-to-self frame) is used to notify another STA to wait for complete transmission of the data frame and the Ack frame. In this way, all STAs that monitor the CTS frame (CTS-to-self frame) set the NAV timers based on the value provided in the CTS frame.

In some embodiments, regardless of whether an RTS/CTS mechanism or a CTS-to-self mechanism is used to avoid a transmission collision, in the case where an RTS/CTS interaction frame or a CTS-to-self frame is a first transmitted frame, a Duration field in the RTS frame, the CTS frame, or the CTS-to-self frame is used to indicate a total duration of the transmission, that is, the Duration field is used to set an NAV timer to protect a channel.

### NAV Update

In some embodiments, an STA maintains two NAVs. T NAVs maintained by the STA are described hereinafter by taking the 802.11ax standard as an example.

In some examples, a non-AP high efficiency (HE) STA maintains two NAVs. In some examples, an HE AP maintains two NAVs.

In some embodiments, two NAVs maintained by an STA are referred to as an intra-BSS NAV and a basic NAV respectively.

In some embodiments, in the case where the STA receives a physical layer protocol data unit (PPDU), the STA updates an NAV value of the STA based on the PPDU. For example, the intra-BSS NAV is updated based on an intra-BSS PPDU. Alternatively, the basic NAV is updated based on an inter-BSS PPDU or a PPDU that is not an intra-BSS PPDU or inter-BSS PPDU.

For an HE STA (for example, a non-AP HE STA or an HE AP) that maintains two NAVs, in the case where values of two NAV timers are both 0, a virtual carrier sense indication is used to indicate that the transmission medium is idle; and in the case where at least one of the two values is a non-zero value, the virtual carrier sense indication is used to indicate that the transmission medium is busy.

### OBSS Packet Detect (PD)-Based Spatial Reuse (SR) Mechanism

In some embodiments, the STA performs channel access using a carrier sense multiple access with collision avoidance (CSMA/CA) method. In the case where the STA performs channel access using the CSMA/CA method, a CCA mechanism is used to detect whether a channel is idle (that is, to perform physical carrier sense).

The CCA generally includes two thresholds: a signal detect (SD) threshold and an energy detect (ED) threshold. The SD threshold of the CCA indicates a minimum modulation and coding rate sensitivity. In some embodiments, the SD threshold of the CCA is used to detect whether a preamble of a PPDU (for example, an 802.11 PPDU) exists in the channel. In some embodiments, the SD threshold of the CCA is −82 decibel milliwatts (dBm). The ED threshold of the CCA is used to detect whether interference exists in the channel, that is, whether a signal from another heterogeneous network (for example, a Bluetooth device or a microwave oven) exists in the channel. In some embodiments, the ED threshold of the CCA is higher than the SD threshold of the CCA, for example, 20 dBm higher than the SD threshold of the CCA. Taking the SD threshold of the CCA being −82 dBm as an example, the ED threshold of the CCA is −62 dBm.

In some implementations, the STA determines whether a channel is busy by comparing a received signal strength indication (RSSI) of a received signal with the SD threshold of the CCA and the ED threshold of the CCA.

Based on a conventional EDCA contention mechanism, in the case where an AP or an STA detects a transmission signal (for example, a preamble of a PPDU) of another AP or STA (whether belonging to the same BSS) on a current operating channel, the AP or the STA defers transmission until the channel is idle. In the presence of the OBSS, in the case where an EDCA mechanism is used for transmission, transmission is only performed between devices (an AP and/or an STA) within a same BSS in a period of time (for example, a transmission opportunity), such that the transmission efficiency is low.

In view of the above problems, an OBSS PD-based SR mechanism is introduced in the IEEE 803.11ax. The OBSS PD-based SR mechanism may resolve the problem of co-channel OBSS interference by identifying non-associated BSS packets and controlling and adjusting its own transmit power, to achieve the effect of spatial reuse, improve the overall throughput of the current channel, and improve the transmission efficiency.

In some implementations, in the IEEE 802.11ax protocol, BSS color information is added to an HE-SIG-A field of the preamble of the PPDU to assist an STA (for example, an HE STA) in identifying the BSS information of the received PPDU. The value range of the BSS color is not limited in the embodiments of the present disclosure. Exemplarily, the value range of the BSS color is 1 to 63.

In some embodiments, in the case where the BSS color indicated in the PPDU received by the STA is the same as the BSS color of the associated AP, the PPDU received by the STA is an intra-BSS PPDU; otherwise, the PPDU is an inter-BSS PPDU.

In some embodiments, in the case where the PPDU received by the STA does not indicate the BSS color, or the STA fails to determine the BSS color indicated by the received PPDU, the PPDU received by the STA is an inter-BSS PPDU.

In some embodiments, in the case where a value of an RSSI of an inter-BSS PPDU received by the STA is less than a current value of OBSS_PD, the STA ignores interference caused by the PPDU to the transmission performed by the STA, and adjusts its own transmit power to an appropriate value for transmission.

It should be noted that the value of OBSS_PD may be determined based on the SD threshold of the CCA and the ED threshold of the CCA. For example, a maximum value of OBSS PD is the ED threshold of the CCA, and a minimum value of OBSS_PD is the SD threshold of the CCA.

FIG. 5 shows an example in which an STA adjusts OBSS_PD and the transmit power. As shown in FIG. 5, an OBSS_PD value ranges from the maximum value (usually −62 dBm) of OBSS_PD to the minimum value (usually −82 dBm) of OBSS_PD. The STA adaptively adjusts the OBSS_PD value within a range between the maximum value of OBSS_PD and the minimum value of OBSS_PD, and adjust its own transmit power to an appropriate value for transmission. For example, the STA adaptively adjusts an OBSS_PD value within a range between a maximum value of OBSS_PD and a minimum value of OBSS_PD, adjusts its own transmit power within a transmit power reference value range, and then performs transmission based on the adjusted OBSS_PD value and transmit power.

### PSR Mechanism

In some embodiments, a PSR mechanism is introduced in some practices (such as IEEE 802.11ax) to improve the transmission efficiency.

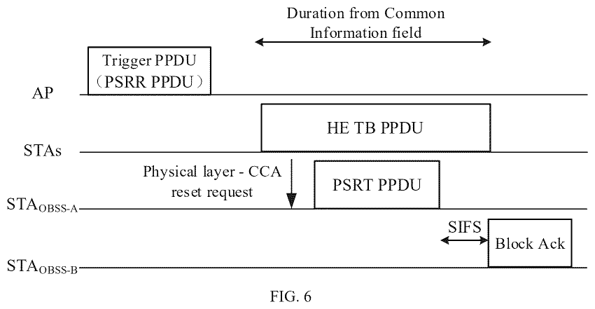

The PSR mechanism is described hereinafter with reference to FIG. 6. Referring to FIG. 6, in the PSR mechanism, after an AP acquires a transmission opportunity, an STA triggers an OBSS by a trigger frame to further perform transmission in the case where the AP performs uplink reception. That is, the STA simultaneously performs transmission with the AP by the trigger frame. For example, in the case where conditions intended to avoid interference to reception of the transmitting PPDU by the receiver are satisfied, the STA initiates spatial reuse (SR) transmission in a PSR opportunity during an ongoing PPDU. An OBSS STA identifying a PSR opportunity should not transmit a parameterized spatial reuse transmission (PSRT) PPDU that exceeds a PPDU duration of an HE trigger-based (TB) PPDU triggered by a trigger frame of a parameterized spatial reuse reception (PSRR) PPDU.

The PSRR PPDU refers to a PPDU including a trigger frame, and a value of the trigger frame is neither PSR_DISALLOW nor PSR_AND_NON_SRG_OBSS_PD_PROHIBITED in an Uplink (UL) Spatial Reuse subfield of a Common Information (Info) field. The PSRT PPDU refers to a PPDU transmitted by an HE STA in a PSR opportunity in the case where a PSR condition of a PSR-based spatial reuse operation is satisfied and the value of the SR PPDU subfield in the CAS Control field is 1.

In some embodiments, in order to ensure that the transmission performed by an OBSS device that uses the PSR opportunity does not affect uplink reception of the AP, a trigger frame carried in the PSRR PPDU includes a PSR field, such that interference calculations performed by the OBSS device are facilitated. In some embodiments, the PSR field includes one or more of: a maximum interference power receivable by the AP without affecting uplink reception of the AP, or a transmit power of the AP.

In some embodiments, upon receiving the above PSRR PPDU, the OBSS device measures a corresponding RSSI, and determines, based on information provided by a PSR field in a trigger frame carried in the PSRR PPDU, whether a transmission medium (or referred to as a channel, a medium, or the like) is accessible and what transmit power is used for transmission.

### Coordinated Spatial Reuse (C-SR) Technology

The OBSS PD-based SR technology and the PSR technology both require that a device using a spatial reuse opportunity needs to reduce the transmit power of the device to limit the generated interference, and a transmitter device that uses the spatial reuse opportunity adjusts only based on interference to the transmitter device, without considering interference to a peer receiver device, because the transmitter device does not know and cannot control the interference to the peer device. Therefore, in a dense deployment scenario a scenario in which transmission failure is not withstood, or a scenario of excessive channel access latency (for example, delay-sensitive data traffic needs to be transmitted), the two technologies both face challenges. Based on this, a C-SR technology is proposed to optimize the two technologies. The C-SR technology may acquire more and more accurate OBSS interference information to perform closer coordination with a plurality of APs, such that the transmission efficiency is improved.

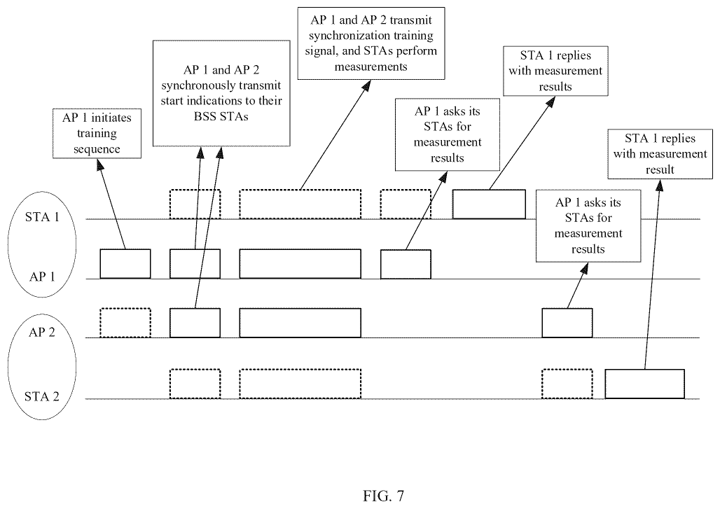

In some embodiments, in the case where the C-SR technology is used for transmission, the C-SR coordination phase includes two coordination phases, that is, a multi-AP coordinated measurement phase and a multi-AP coordinated transmission phase. Two coordination phases in the C-SR technology are described hereinafter with reference to FIGS. 7 to 9.

The plurality of APs acquire, through a coordinated measurement phase, the OBSS interference information measured by each STA in each BSS. FIG. 7 shows an exemplary diagram of the process of a multi-AP coordinated measurement phase. As shown in FIG. 7, in the coordinated measurement phase, AP 1 and AP 2 respectively transmit indication information to associated STAs to instruct the STAs to measure the OBSS information, and receive the OBSS information measured by the STAs. For example, AP 1 transmits indication information to STA 1 to instruct STA 1 to measure the OBSS information, and receives the OBSS information measured by STA 1; and AP 2 transmits indication information to STA 2 to instruct STA 2 to measure the OBSS information, and receives the OBSS information measured by STA 2.

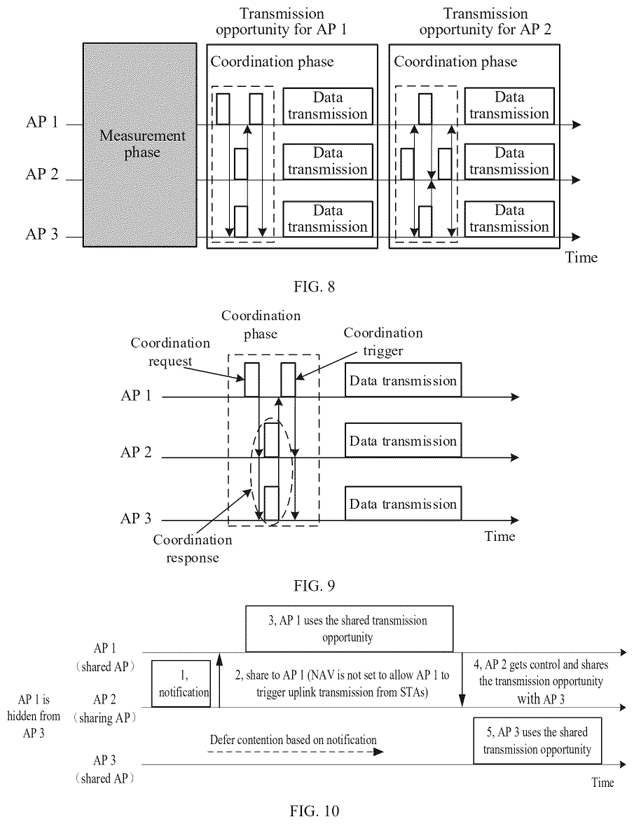

In the multi-AP coordinated transmission phase, each AP coordinates (or negotiates) with another AP for simultaneous transmission within its own transmission opportunity. FIG. 8 shows an exemplary diagram of the process of multi-AP coordinated measurement and coordinated transmission. As shown in FIG. 8, upon acquiring the OBSS interference information in the coordinated measurement phase, the plurality of APs coordinate the transmission between the APs based on the acquired OBSS interference information. For example, during the transmission opportunity of AP 1, AP 1 coordinates AP 2 and AP 3 to perform transmission within the transmission opportunity of AP 1; and in the transmission opportunity of AP 2, AP 2 coordinates AP 1 and AP 3 to perform transmission within the transmission opportunity of AP 2.

In some implementations, the coordinated transmission is performed based on a request-response manner. For example, a coordinating AP transmits a coordination request to a coordinated AP to request the coordinated AP to perform coordinated transmission; and then, upon receiving the coordination request, the coordinated AP transmits a coordination response to the coordinating AP to indicate participation in the coordinated transmission. Then, the coordinating AP transmits a coordination trigger frame to the coordinated AP to start data transmission. Taking FIG. 9 as an example, within the transmission opportunity of AP 1, the AP 1, as a coordinating AP, transmits a coordination request to AP 2 and AP 3 and receives coordination responses from AP 2 and AP 3. Then, AP 1, AP 2, and AP 3 start data transmission based on a coordination trigger frame transmitted by the AP 1.

### C-TDMA Mechanism

In the presence of the OBSS, in the case where an EDCA mechanism is used for transmission, transmission is only performed between devices (an AP and/or an STA) within a same BSS in a period of time (for example, a transmission opportunity), such that transmission of other BSSs is deferred. Based on this, a C-TDMA technology is introduced in some practices to improve the transmission delay of the BSS by sharing a transmission opportunity between APs. It should be noted that the C-TDMA mechanism essentially performs channel access scheduling with a smaller time granularity (a time granularity smaller than a transmission opportunity) between a plurality of APs without increasing channel contention access load.

In the C-SR technology, the OBSS device may fail to use a spatial reuse opportunity because the maximum transmit power allowed by the OBSS device may be insufficient to support the OBSS device in successfully transmitting the PPDU to the receiver. However, the C-TDMA mechanism may avoid this problem by separating the transmissions of the OBSS devices in the time domain. In addition, the C-TDMA mechanism may further improve the transmission delay of the OBSS device. The C-TDMA mechanism is described hereinafter in more detail with reference to FIG. 10.

Upon acquiring a transmission opportunity, an AP (a sharing AP) shares a part of the time with another AP (a shared AP). The shared AP performs transmission with the STA associated with the shared AP within the shared transmission duration, and then returns the channel access right to the sharing AP upon expiration of the shared transmission duration. Within the transmission opportunity of the sharing AP, another AP that is not granted a transmission opportunity defers channel access within the shared transmission duration.

As shown in FIG. 10, upon acquiring a transmission opportunity, AP 2 (as a sharing AP) shares a part of the time in the transmission opportunity with AP 1 (as a shared AP). Within the part of the time, AP 3 (as an AP that is not granted a transmission opportunity, or referred to as another AP) needs to defer channel access. Then, AP 1 returns the channel access right to AP 2 upon expiration of the shared transmission duration, and AP 2 shares a part of the time (different from the part of the time shared with the AP 1) in the transmission opportunity with AP 3 (as a shared AP) upon acquiring the channel access right. In this way, AP 3 performs transmission within the part of the time shared by AP 1 with AP 3. Within the part of the time shared by AP 1 with AP 3, AP 1 (as an AP that is not granted a transmission opportunity, or referred to as another AP) needs to defer channel access.

It can be seen from the above description that different technologies are introduced in some practices to improve the transmission efficiency, but each of the technologies has some problems.

Taking the C-SR technology as an example, in the C-SR technology, a plurality of APs toned to be coordinated prior to transmission, and a coordinating AP (an AP located in its own transmission opportunity) needs to perform complex coordination calculations. In general, the coordinating AP needs to know the buffer status (that is, transmission requirements) of other coordinated APs during or prior to coordination. In the case where a plurality of APs performs the coordination prior to each transmission, the coordination load is large. In the case where a plurality of APs performs several transmissions upon one coordinating, adjustment may not be performed in time based on the transmission requirements of the coordinated APs, which is not conducive to the transmission of low-delay data (especially unpredictable low-delay data). In addition, in the case where the C-SR technology is used for transmission, strict PPDU alignment is required, such that a time synchronization requirement is stringent. Moreover, the PPDU alignment may require padding. In the case where amounts of the to-be-transmitted data of the coordinated APs are greatly different, more padding is required, such that the overall transmission efficiency is reduced.

Taking the C-TDMA technology as an example, a sharing AP may share a transmission opportunity with only one shared AP each time, and another AP that are not granted a transmission opportunity need to defer channel access within the shared transmission opportunity, such that the channel utilization rate is low. In some implementations, in the case where a sharing AP shares a transmission opportunity with a plurality of shared APs each time, the sharing AP needs to perform complex coordination calculations. For example, the difference in the amounts of the to-be-transmitted data of the shared APs may cause that the transmission duration shared with the shared APs is difficult to determine. In addition, in the case where the sharing AP shares a transmission opportunity with a plurality of shared APs each time, the sharing AP further needs to process a case of a collision caused by advanced return from the plurality of shared APs.

In view of the above problems, embodiments of the present disclosure provide a method for communication and an apparatus for communication to ensure that an AP that is not granted a transmission opportunity may also perform transmission within a transmission opportunity shared by a sharing AP with a shared AP, such that simultaneous transmission of a plurality of APs without interference or with minimal interference is ensured, and the channel utilization rate is improved.

Prior to description of the embodiments of the present disclosure, an application scenario to which the embodiments of the present disclosure are applicable is first described using examples.

In some embodiments, the embodiments of the present disclosure are applicable to a multi-AP scenario, for example, a scenario including three or more APs. Alternatively, in some embodiments, the embodiments of the present disclosure are applicable to a densely deployed multi-AP scenario.

In some embodiments, the embodiments of the present disclosure are applicable to a multi-BSS scenario, for example, a scenario including three or more BSSs. In some embodiments, in the case where the embodiments of the present disclosure are applicable to a multi-BSS scenario, some or all of the plurality of BSSs are overlapped with each other. That is, in some embodiments, the embodiments of the present disclosure are applicable to an OBSS scenario.

In some embodiments, in an application scenario of the embodiments of the present disclosure, some APs, or some APs and STAs, or some STAs are hidden nodes for each other. That is, some APs, or some APs and STAs, or some STAs may not directly receive a PPDU or a frame from each other.

In some embodiments, in an application scenario of the embodiments of the present disclosure, some APs, or some APs and STAs, or some STAs are exposed nodes for each other. That is, some APs, or some APs and STAs, or some STAs may directly receive a PPDU or a frame from each other. In some embodiments, transmissions between exposed nodes cause interference to each other, such that frequent retransmission of data between the nodes is required, and the channel utilization rate (or reduced spectral efficiency) is reduced.

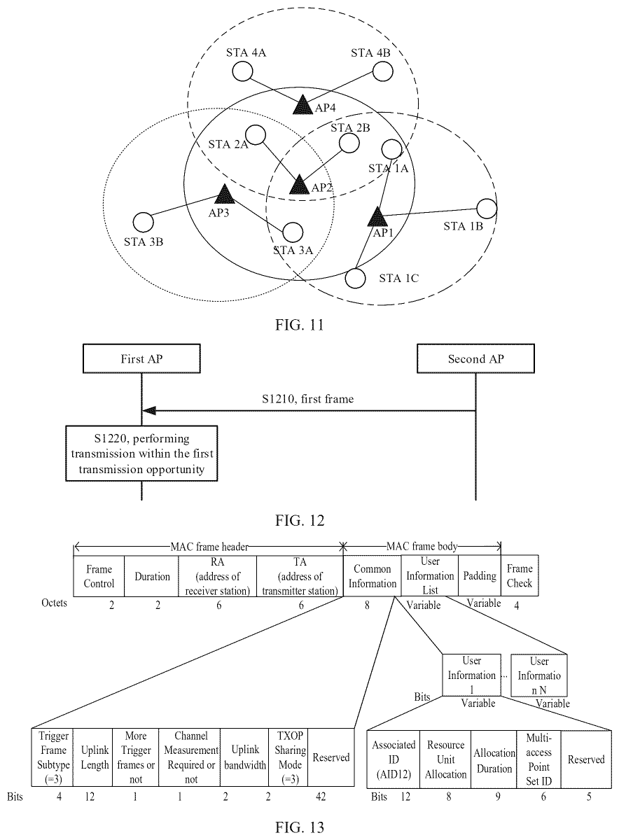

Exemplarily, FIG. 11 shows an example of an application scenario to which some embodiments of the present disclosure are applicable. As shown in FIG. 11, the application scenario includes four APs, and the four APs are identified by AP 1, AP 2, AP 3, and AP 4. In the example, AP 1, AP 3, and AP 4 are hidden nodes for each other, that is, AP 1, AP 3, and AP 4 may not receive a PPDU from each other. Similarly, in the example, STA 3B and AP 1 are hidden nodes for each other, STA 4B and AP 1 are hidden nodes for each other, and so on. In the example, AP 2 is an exposed node for AP 1, AP 3, or AP 4. That is, in the case where AP 2 performs transmission with an associated station, the transmission may cause interference to the transmission between AP 1, AP 3, or AP 4 and their own associated stations; or in the case where AP 1, AP 3, or AP 4 performs transmission with their own associated stations, the transmission may cause interference to the transmission between the AP 2 and the associated station. Such interference may lead to frequent retransmissions, such that the channel utilization rate is reduced.

The method embodiments of the present disclosure are described hereinafter with reference to the accompanying drawings.

FIG. 12 is a schematic flowchart of a method for communication according to some embodiments of the present disclosure. The method shown in FIG. 12 is described from a perspective of interaction between a first AP and a second AP. The first AP and the second AP may be, for example, two APs in the scenario shown in FIG. 11. For example, the first AP is AP 3 or AP 4, and the second AP is AP 2. For ease of understanding, the first AP and the second AP are first described.

The second AP is an AP that actively shares its own transmission opportunity. Alternatively, the second AP acts as a sharing AP. For example, the second AP shares its own transmission opportunity with a shared AP.

In some embodiments, the second AP shares a part of the transmission duration within a transmission opportunity with the shared AP. However, the embodiments of the present disclosure are not limited thereto. In some embodiments, the second AP shares the entire transmission opportunity with the shared AP.

In some embodiments, the second AP shares a transmission opportunity with only one shared AP each time. For example, upon acquiring a transmission opportunity, the second AP shares the transmission opportunity with a third AP (a shared AP). Then, after the third AP completes the transmission and returns the control of the transmission opportunity to the second AP, the second AP re-shares the transmission opportunity with a fourth AP (another shared AP).

That is, although in the foregoing example, the second AP shares a transmission opportunity with different shared APs (the third AP and the fourth AP), the transmission opportunity is shared with only one shared AP at a time. For example, the transmission opportunity is shared with only the third AP for the first time, and is shared with only the fourth AP for the second time, and is shared with both the third AP and the fourth AP.

The first AP is an AP that is not granted the transmission opportunity by the second AP, but the first AP still performs transmission within the transmission opportunity shared by the second AP. For example, upon the second AP shares the transmission opportunity with the third AP (but does not share the transmission opportunity with the first AP), the first AP performs transmission within the transmission opportunity that is shared by the second AP with the third AP.

In some embodiments, the first AP and the second AP share a channel (or referred to as a transmission medium, a medium, or the like), or the first AP and the second AP perform transmission on a same channel. In this case, the first AP performs transmission on a channel shared by the first AP and the second AP within a transmission opportunity shared by the second AP.

In some embodiments, the first AP is an AP adjacent to the second AP, or the first AP is an AP near the second AP. However, the embodiments of the present disclosure are not limited thereto, provided that the first AP and the second AP perform transmission on a same channel, and the first AP performs transmission within a transmission opportunity of the second AP.

In some embodiments, the first AP is a hidden node for the third AP, or the first AP is a hidden node relative to the third AP. That is, the first AP may not receive a PPDU from the third AP, or the first AP may not receive a frame from the third AP.

The method shown in FIG. 12 includes S1210 and S1220. The processes are described hereinafter.

In S1210, the first AP receives a first frame from the second AP.

In some embodiments, the first frame is used for the second AP to share a first transmission opportunity with the third AP.

In some embodiments, the third AP is any shared AP corresponding to the second AP.

In some embodiments, the first frame is used for the second AP to share the first transmission opportunity with a shared AP, namely, the third AP. That is, the first frame is used to instruct the second AP to share the first transmission opportunity with only the third AP, but does not share the transmission opportunity with the first AP.

In some embodiments, the first frame is transmitted by the second AP to one or more APs. For example, the first frame is broadcast by the second AP. In this way, the one or more APs (for example, the third AP and the first AP) all receive the first frame from the second AP.

In S1220, the first AP performs transmission within the first transmission opportunity.

In some embodiments, upon receiving the first frame, the first AP determines related information of the first transmission opportunity based on information in the first frame, and performs transmission within the first transmission opportunity based on the related information of the first transmission opportunity. Related content of the information in the first frame is specifically described below, and is not described in detail herein.

In the embodiments of the present disclosure, after the second AP shares the transmission opportunity with the third AP, the first AP performs transmission within the shared transmission opportunity. That is, in the case where the second AP does not share the transmission opportunity with the first AP, the first AP performs transmission within the transmission opportunity shared by the second AP, such that simultaneous transmission of a plurality of APs without interference or with minimal interference is ensured, and one or more of the following cases are achieved, that is, improving the channel utilization rate, improving the spectral efficiency, improving the system throughput, and reducing the transmission delay.

Compared with the C-TDMA mechanism, in the embodiments of the present disclosure, a plurality of APs without interference or with minimal interference simultaneously perform transmission, such that the channel utilization rate is improved.

Compared with the C-SR mechanism, in the embodiments of the present disclosure, the spatial reuse is achieved, the system throughput is improved, and a coordinating AP does not need to coordinate with a plurality of coordinated APs prior to each transmission. In addition, in the embodiments of the present disclosure, a coordinating AP does not need to perform complex coordination calculations. In addition, in the embodiments of the present disclosure, each AP implements more timely scheduling based on a buffer status of the AP, which is more conducive to transmission of low-latency data (especially unpredictable low-latency data).

In some embodiments, the C-SR mechanism is understood as a mechanism for implementing spatial reuse in a centralized scheduling manner. That is, the coordinating AP needs to centrally coordinate transmission between a plurality of APs. Compared with the C-SR mechanism, the embodiments of the present disclosure are understood as a distributed autonomous scheduling manner. In the embodiments of the present disclosure, each AP has higher autonomy and may greatly process a low-latency data transmission requirement. In addition, the C-SR mechanism needs to support more EDCA parameters in a centralized scheduling manner to implement transmission fairness of devices. However, in the embodiments of the present disclosure, transmission fairness of devices is not affected in the distributed scheduling manner.

In some embodiments, the transmission performed by the first AP within the first transmission opportunity is conditional. That is, within the first transmission opportunity, the first AP and the associated stations (such as the first station) perform conditional transmission. This is because the first transmission opportunity is shared by the second AP with the third AP, and transmission performed by the first AP and related transmission performed by the third AP and/or the second AP should not affect each other in the case where the first AP performs transmission within the first transmission opportunity. For example, transmission performed by the first AP and related transmission performed by the third AP should not affect each other, and/or transmission performed by the first AP and related transmission performed by the second AP should not affect each other. Alternatively, transmission between the first AP and the associated station and transmission between the second AP and the associated station should not affect each other, and transmission between the first AP and the associated station and transmission between the third AP and the associated station should not affect each other.

The first AP performs conditional transmission within the first transmission opportunity, such that the transmission performed by the first AP and the transmission performed by the third AP do not affect each other, and the channel utilization rate is improved.

It should be noted that the station associated with the AP in the embodiments of the present disclosure is understood as that the station belongs to the AP. For example, the first station associated with the first AP is understood as that the first station belongs to the first AP. Alternatively, the station associated with the second AP is understood as that the station belongs to the second AP, or the like. In some embodiments, the station associated with the AP is also understood as a station that belongs to a same BSS as the AP. For example, in the case where the first AP and the first station belong to a same BSS, the first station is understood as a station associated with the first AP. In some embodiments, the station associated with the AP is also understood as that the station accesses a network through the AP. For example, in the case where the first station accesses a network through the first AP, the first station is understood as a station associated with the first AP.

The type of the station associated with the AP is not limited in the embodiments of the present disclosure. In some embodiments, the station associated with the AP includes an HE station. In some embodiments, the station associated with the AP includes an extremely high throughput (EHT) station. In some embodiments, the station associated with the AP includes an HE station and an EHT station.

In some embodiments, the station associated with the AP in the embodiments of the present disclosure is also referred to as or replaced with a station associated with the AP. For example, the first station associated with the first AP is replaced with the first station associated with the first AP.

The conditional transmission performed by the first AP within the first transmission opportunity is described hereinafter.

In some embodiments, in the case where the first AP performs transmission within the first transmission opportunity, one or more of the following problems need to be considered, that is, whether a station associated with the third AP experiences interference from transmission performed by the first AP, whether a station associated with the first AP experiences interference from transmission performed by the third AP, or whether the second AP may get control of the first transmission opportunity in time upon complete transmission performed by the third AP.

Whether the second AP may get control of the first transmission opportunity in time upon complete transmission performed by the third AP is understood as whether the second AP may control the first transmission opportunity in time upon complete transmission performed by the third AP. In some embodiments, control by the second AP over the first transmission opportunity is affected by one or more of the following factors that: in a case where the third AP transmits a transmission completion indication frame to the second AP upon completing transmission, the transmitted transmission completion indication frame experiences interference from transmission performed by the first AP, such that the transmission completion indication frame is not received by the second AP; or the transmission performed by the first AP causes a busy channel, such that the second AP fails to notify the first AP to terminate the transmission.

For example, upon completing transmission, the third AP transmits a contention free-end (CF-End) indication frame to the second AP to indicate that the third AP has completed transmission. However, due to interference from transmission performed by the first AP, the CF-End indication frame from the third AP is not received by the second AP, such that the second AP fails to control the first transmission opportunity in time.

For example, upon completing transmission, the third AP transmits a CF-End indication frame to the second AP to indicate that the third AP has completed transmission. Although the second AP normally receives the CF-End indication frame, a busy channel is produced as the first AP is performing transmission within the first transmission opportunity, such that the second AP fails to notify the first AP to terminate the transmission, and the second AP fails to control the first transmission opportunity in time.

In some embodiments, the first AP performing the conditional transmission within the first transmission opportunity is understood as that the first AP performs transmission within the first transmission opportunity in the case where a first condition is satisfied.

In the embodiments of the present disclosure, the first condition is associated with one or more factors. Exemplarily, the first condition is associated with one or more of: information indicating whether the transmission performed by the first AP and the transmission performed by the second AP affect each other; information indicating whether the transmission performed by the first AP and the transmission performed by the third AP affect each other; or information indicating whether the transmission performed by the first AP affects control by the second AP over the first transmission opportunity (that is, whether the transmission performed by the first AP affects the second AP in getting control of the first transmission opportunity).

That is, the first condition is associated with one or more of: information indicating whether the transmission performed by the first AP affects the transmission performed by the second AP; information indicating whether the transmission performed by the first AP affects the transmission performed by the third AP; information indicating whether the transmission performed by the second AP affects the transmission performed by the first AP; information indicating whether the transmission performed by the third AP affects the transmission performed by the first AP; or information indicating whether the transmission performed by the first AP affects control by the second AP over the first transmission opportunity.

In some embodiments, the first AP being capable of performing transmission within the first transmission opportunity in the case where the first condition is satisfied is understood as that the first AP performs transmission within the first transmission opportunity in the case where the transmission performed by the first AP and the transmission performed by the second AP do not affect each other, and/or the transmission performed by the first AP and the transmission performed by the third AP do not affect each other, and/or the transmission performed by the first AP does not affect the control by the second AP over the first transmission opportunity.

Exemplarily, the first condition includes one or more of: information indicating that the transmission between the first AP and the first station does not affect the transmission performed by the second AP (for example, transmission between the second AP and a station associated with the second AP); information indicating that the transmission between the first AP and the first station does not affect the transmission performed by the third AP; information indicating that the transmission between the second AP and a station associated with the second AP does not affect the transmission between the first AP and the first station; information indicating that the transmission between the third AP and a station associated with the third AP does not affect the transmission between the first AP and the first station; or information indicating that the transmission between the first AP and the first station does not affect the control by the second AP over the first transmission opportunity (that is, transmission between the first AP and the first station does not affect the second AP in backer-acquiring the control of the first transmission opportunity).

The first station is a station associated with the first AP. It should be noted that the first station is any station associated with the first AP. That is, one or more stations associated with the first AP are present, and the first station is any one of the one or more stations associated with the first AP, which is not limited in the embodiments of the present disclosure.

In some embodiments, the first AP performing the conditional transmission within the first transmission opportunity is understood as that the first AP performs transmission within the first transmission opportunity in the case where the second AP successfully shares the first transmission opportunity with the third AP. That is, in some embodiments, prior to performing transmission within the first transmission opportunity, the first AP needs to first determine whether the second AP successfully shares the first transmission opportunity with the third AP.

In some embodiments, in the case where the second AP fails to share the first transmission opportunity with the third AP, the first AP may not perform transmission within the first transmission opportunity.

The implementations of determining whether the first transmission opportunity is successfully shared are not limited in the embodiments of the present disclosure. In some implementations, the first AP determines, by detecting whether a channel is idle, whether the first transmission opportunity is successfully shared. In some implementations, the second AP and/or the third AP indicates, to the first AP, whether the first transmission opportunity is successfully shared.

The implementations in which the first AP determines, by detecting whether a channel is idle, whether the first transmission opportunity is successfully shared are described hereinafter in detail.

Exemplarily, whether the first transmission opportunity is successfully shared is determined based on one or more of the following methods: the first AP detecting whether the channel shared by the first AP and the second AP (or the third AP) is idle within a first duration; or after a period of time since receipt of the first frame, the first AP detecting whether the channel shared by the first AP and the second AP (or the third AP) is idle within the first duration.

For example, in the case where the first AP detects that the channel shared by the first AP and the second AP (or the third AP) is idle within the first duration, the first AP determines that the second AP successfully shares the first transmission opportunity with the third AP.

For example, in the case where the first AP detects, after a period of time since receipt of the first frame, that the channel shared by the first AP and the second AP (or the third AP) is idle within the first duration, the first AP determines that the second AP successfully shares the first transmission opportunity with the third AP.

For example, in the case where the first AP detects that the channel shared by the first AP and the second AP (or the third AP) is busy within the first duration, the first AP determines that the second AP fails to share the first transmission opportunity with the third AP.

For example, in the case where the first AP detects, after a period of time since receipt of the first frame, that the channel shared by the first AP and the second AP (or the third AP) is busy within the first duration, the first AP determines that the second AP fails to share the first transmission opportunity with the third AP.

In some embodiments, the first duration is used to indicate the duration required by the third AP to respond to the first frame.

In some embodiments, the first duration is related to one or more of: a duration of a CTS frame, a short interframe space, a duration of a slot, and the like.

In some embodiments, the first duration is obtained by performing a summation operation on a duration of a CTS frame, a short interframe space, and a duration of a slot.

For example, the first duration is equal to a sum of duration of a CTS frame, a short interframe space, and a duration of two slots. That is, the first duration is acquired by the following equation (1).

$${T}_{first} = CTSTxTime + aSIFSTime + 2 * aSlotTime \qquad ( Equation 1 )$$

T_{first} represents the first duration, CTST×Time represents the duration of the CTS frame, aSIFSTime represents the short interframe space, and aSlotTime represents the duration of the slot.

However, the embodiments of the present disclosure are not limited thereto. In some examples, the first duration is alternatively equal to another value such as a sum of duration of a CTS frame, a short interframe space, and a duration of a slot.

In some embodiments, the short interframe space and the duration of the slot are predefined durations, for example, durations predefined in a protocol.

In some embodiments, the duration of the CTS frame is used to indicate a duration required for the third AP to transmit the CTS frame to the second AP. For example, the duration of the CTS frame is used to indicate an estimated duration for the third AP to transmit a PPDU carrying the CTS frame at a lowest supported transmission rate or by a modulation and coding scheme.

The time when the first AP starts to detect whether the channel is idle within the first duration is not limited in the embodiments of the present disclosure. In some embodiments, upon receiving the first frame, the first AP immediately starts to detect whether the channel shared by the first AP and the second AP (or the third AP) is idle within the first duration. In some embodiments, after a period of time since receipt of the first frame, the first AP starts to detect whether the channel shared by the first AP and the second AP (or the third AP) is idle within the first duration.

The duration of the above period of time is not limited in the embodiments of the present disclosure. The period of time is randomly set based on actual requirements. Exemplarily, the duration of the period of time is determined based on the short interframe space. For example, the duration of the period of time is equal to a short interframe space. Alternatively, the duration of the period of time is equal to two short interframe spaces, or the like.

It should be understood that a reason why the first AP may determine, by detecting whether the channel is idle, whether the first transmission opportunity is successfully shared is as follows: in the case where the first AP detects, within the first duration, that the channel is idle all the time (the first AP is a hidden node for the third AP, and thus fails to receive a CTS frame from the third AP), the first transmission opportunity has been successfully shared with the third AP; otherwise, the second AP performs new downlink transmission upon failing to share the first transmission opportunity, and the channel is thus busy.

In some embodiments, prior to performing transmission within the first transmission opportunity, the first AP needs to contend for a usage right of the first transmission opportunity. In some implementations, prior to performing transmission within the first transmission opportunity, the first AP contends for the second transmission opportunity.

In some embodiments, the second transmission opportunity is located within the first transmission opportunity. In some embodiments, the transmission duration of the second transmission opportunity is not greater than the transmission duration of the first transmission opportunity; that is, the transmission duration of the second transmission opportunity is less than or equal to the transmission duration of the first transmission opportunity.

The implementations in which the first AP contends for the second transmission opportunity are not limited in the embodiments of the present disclosure. Several implementations in which the first AP contends for the second transmission opportunity are described hereinafter using examples.

First implementations: The first AP contends for the second transmission opportunity through an EDCA mechanism. In some implementations, the first AP acquires the second transmission opportunity through contention within the first transmission opportunity using a control frame (such as an RTS frame or a first frame). In this case, a station in the stations associated with the first AP causing interference to transmission performed by the third AP and/or the second AP does not respond to the CTS because an NAV timer (such as a basic NAV timer) indicates that a virtual transmission medium is in a busy state, and another station associated with the first AP responds to the CTS to contend for the second transmission opportunity.

Using an example of the application scenario shown in FIG. 11, it is assumed that the first AP is AP 3, the second AP is AP 2, the third AP is AP 1, and a station in stations associated with the first AP causing interference to transmission performed by the third AP and/or the second AP is STA 3A. Within the first transmission opportunity, AP 3 acquires the second transmission opportunity through contention using a control frame. In this case, STA 3A does not respond to the CTS because the NAV timer indicates that the virtual transmission medium is in the busy state, and STA 3B responds to the CTS.

Second implementations: the first AP contends for the second transmission opportunity through an OBSS PD-based SR mechanism. In some implementations, within the first transmission opportunity, the first AP acquires the second transmission opportunity through contention using a control frame (such as an RTS frame or a first frame). In this case, a station in the stations associated with the first AP causing interference to transmission performed by the third AP and/or the second AP transmits, based on interference to the station, a CTS response through the OBSS PD-based SR mechanism, and another station associated with the first AP also responds to the CTS to contend for the second transmission opportunity.

Using an example of the application scenario shown in FIG. 11, it is assumed that the first AP is AP 3, the second AP is AP 2, the third AP is AP 1, and a station in stations associated with the first AP causing interference to transmission performed by the third AP and/or the second AP is STA 3A. Within the first transmission opportunity, AP 3 acquires the second transmission opportunity through contention using a control frame. In this case, STA 3A transmits, based on interference to STA 3A, a CTS response through the OBSS PD-based SR mechanism, and the STA 3B also responds to the CTS.

Using an example of the application scenario shown in FIG. 11, it is assumed that the first AP is AP 4, the second AP is AP 2, the third AP is AP 1, and a station in stations associated with the third AP causing interference to transmission performed by the first AP is STA 1A. Within the first transmission opportunity, AP 4 contends for, based on interference to AP 4, the second transmission opportunity through the OBSS PD-based SR mechanism using a control frame.

Third implementations: The first AP excludes a station in one or more stations associated with the first AP that has a transmission collision with the third AP and/or the second AP and then contends for the second transmission opportunity. In some implementations, within the first transmission opportunity, in the case of acquiring the second transmission opportunity through contention using a control frame (such as an RTS frame or a first frame), the first AP excludes a station in stations associated therewith that has a transmission collision with the third AP and/or the second AP. In this case, in the case where the first AP successfully acquires the second transmission opportunity through contention, the first AP performs transmission, within the second transmission opportunity, with only another station other than the colliding station.

In some embodiments, the third implementations are understood as a contention manner in which the first AP actively excludes (actively filters out) a station having a transmission collision with the third AP and/or the second AP.

Using an example of the application scenario shown in FIG. 11, it is assumed that the first AP is AP 3, the second AP is AP 2, the third AP is AP 1, and a station in stations associated with the first AP causing interference to transmission performed by the third AP and/or the second AP is STA 3A. Within the first transmission opportunity, AP 3 excludes STA 3A in the case of acquiring the second transmission opportunity through contention using a control frame (such as an RTS frame or a first frame). In this case, in the case where AP 3 successfully acquires the second transmission opportunity through contention, AP 3 performs transmission, within the second transmission opportunity, only with STA 3B but not STA 3A.

Fourth implementations: The first AP contends for the second transmission opportunity in the case of determining that the third AP does not perform transmission with a second station associated with the third AP. In some embodiments, the second station is any one of one or more stations associated with the third AP, and the transmission performed by the first AP affects the transmission between the second station and the third AP, and/or the transmission between the second station and the third AP affects the transmission performed by the first AP.

The implementations in which the first AP determines that the third AP does not perform transmission with the second station is not limited in the embodiments of the present disclosure. For example, the third AP notifies the first AP that the third AP does not perform transmission with the second station. For example, the third AP notifies the first AP its associated stations with which the third AP does not perform transmission, such that the first AP determines whether the third AP transmits with the second station. For example, the second AP notifies the first AP that the third AP does not perform transmission with the second station. For example, in the case where the third AP and the first AP are hidden nodes for each other, the third AP notifies, through the second AP, the first AP that the third AP does not perform transmission with the second station.

In the case where the first AP determines that the third AP does not perform transmission with the second station, the first AP contends for the second transmission opportunity in one or more manners. In some implementations, the first AP contends for the second transmission opportunity in the above first implementations (that is, through the EDCA mechanism). In some implementations, the first AP contends for the second transmission opportunity in the above second implementations (that is, through the OBSS PD-based SR mechanism).

Using an example of the application scenario shown in FIG. 11, it is assumed that the first AP is AP 4, the second AP is AP 2, the third AP is AP 1, and a station in stations associated with the third AP causing interference to transmission performed by the first AP is STA 1A (that is, the second station is STA 1A). Within the first transmission opportunity, in the case where AP 4 is informed that AP 1 does not perform transmission with STA 1A within the first transmission opportunity, AP 4 contends for the second contention opportunity, and for example, through the EDCA mechanism or the OBSS PD-based SR mechanism.

In some embodiments, in the case where the transmission performed by the first AP affects the transmission between the third AP and a station (for example, the second station) associated with the third AP, the first AP does not contend for the second transmission opportunity. That is, in the case where the transmission between the first AP and the associated station affects the transmission between the third AP and the associated station, the first AP does not contend for the second transmission opportunity.

Using an example of the application scenario shown in FIG. 11, it is assumed that the first AP is AP 4, the second AP is AP 2, the third AP is AP 1, and the transmission performed by the first AP causes interference to transmission between the third AP and STA 1A. In this case, within the first transmission opportunity, the AP 4 does not contend for the second transmission opportunity to avoid interference caused by transmission performed by AP 4 to transmission performed by STA 1A.

In some embodiments, in the case where stations (such as the first station) associated with the first AP contend for the first transmission opportunity, the first AP does not respond to the contention of the stations to avoid that the transmission between the stations and the first AP upon acquisition of the first transmission opportunity causes interference to transmission performed by the second AP and/or the third AP. This is because the second AP is difficult to get the control of the first transmission opportunity after the stations acquire the first transmission opportunity.

In some embodiments, the station (such as the first station) that contends for the first transmission opportunity is a hidden node for the second AP. In this case, after the second AP transmits the first frame, the stations do not update NAV timers thereof, such that the stations contend for the first transmission opportunity. Using an example of the scenario shown in FIG. 11, it is assumed that the first AP is AP 3, the second AP is AP 2, and the third AP is AP 1. Within the first transmission opportunity, a station (such as STA 3B) associated with AP 3 contends for the first transmission opportunity. In this case, AP 3 does not respond to contention of STA 3B. Using an example of the scenario shown in FIG. 11, it is assumed that the first AP is AP 4, the second AP is AP 2, and the third AP is AP 1. Within the first transmission opportunity, a station (such as STA 4A and/or STA 4B) associated with AP 4 contends for the first transmission opportunity. In this case, AP 4 does not respond to contention of STA 4A and/or STA 4B.

As mentioned above, the second AP transmits the first frame to indicate, using the first frame, that the first transmission opportunity is shared with the third AP. The first frame is described hereinafter in detail with reference to FIG. 13.

In some embodiments, the first frame is used to trigger the third AP to transmit a CTS frame as a response. Therefore, in some embodiments, the first frame is also referred to as or understood as a trigger frame. For example, the first frame is an RTS frame or a MU-RTS trigger frame.

In some embodiments, the first frame includes first information, and the first information is used to indicate a transmission duration shared by the second AP with the third AP.

In some embodiments, the first information is indicated by a User Information field corresponding to the third AP. For example, the first information is indicated by an Allocation Duration field in the User Information field corresponding to the third AP. Referring to FIG. 13, the first information is indicated by the Allocation Duration field in the user information (such as User Information 1) field.

In some embodiments, the first frame includes a Duration field, and the value of the Duration field is set to a sum of a duration of the first frame, a duration of an SIFS, and a duration of an CTS frame. Referring to FIG. 13, the Duration field is carried in a medium access control (MAC) frame header of the first frame, and the Duration field occupies, for example, two octets.

In some embodiments, the value of the Duration field does not include a transmission duration shared by the second AP with the third AP. This is because in the case where the value of the Duration field includes the transmission duration shared by the second AP with the third AP, a station (such as an HE station and/or an EHT station) associated with the third AP considers, based on setting of an NAV timer (such as a basic NAV timer), that the virtual medium is in a busy state and may not perform uplink transmission.

In some embodiments, the first frame is broadcast by the first AP, or the first frame is transmitted by the first AP in a broadcast manner, such that another AP (such as the first AP) other than the third AP and/or another station also receives the first frame. In some implementations, referring to FIG. 13, a value of a Receiving Address (RA) field in a frame header of the first frame is a broadcast MAC address.

However, the embodiments of the present disclosure are not limited thereto. For example, the first frame is multicast by the first AP or the first frame is transmitted by the first AP in a multicast manner to enable another AP and/or another station to receive the first frame.

In some embodiments, upon receiving the first frame, the first AP parses the first frame to learn that the second AP shares the transmission opportunity between a plurality of APs. In some embodiments, the first AP parses the first frame to learn that the second AP shares the first transmission opportunity with the third AP. For example, the first AP learns, by parsing the User Information field in the first frame, that the first transmission opportunity is shared with the third AP. In some embodiments, the first AP parses the first frame to learn of the transmission duration shared by the second AP with the third AP. For example, the first AP parses the Allocation Duration field in the User Information field in the first frame to learn of the transmission duration shared by the second AP with the third AP.

In some embodiments, the first frame includes one or more of: second information or third information. The second information is used to indicate one or more APs allowed of contending for the first transmission opportunity. That is, the second information is used to indicate one or more APs allowed of contending for a transmission opportunity within the transmission duration shared by the second AP with the third AP. The third information is used to indicate one or more APs disallowed of contending for the first transmission opportunity. That is, the third information is used to indicate one or more APs disallowed of contending for the transmission opportunity within the transmission duration shared by the second AP with the third AP.

For example, the second AP indicates, in the first frame, one or more APs allowed of contending for the first transmission opportunity.

For example, the second AP indicates, in the first frame, one or more APs disallowed of contending for the first transmission opportunity.

In some embodiments, the second AP indicates the second information and/or the third information in the User Information field of the first frame. However, the embodiments of the present disclosure are not limited thereto. For example, the second AP adds a new field to the first frame to indicate the second information and/or the third information.

The implementations of indicating the second information and/or the third information are not limited in the embodiments of the present disclosure. Several implementations are described hereinafter as examples.

In some implementations, the second AP directly indicates the second information in the User Information field in the first frame. That is, the User Information field in the first frame is used to indicate one or more APs allowed of contending for the first transmission opportunity. Exemplarily, the User Information field in the first frame includes a User Information field corresponding to the third AP and a User Information field corresponding to an AP other than the third AP. A User Information field corresponding to each other AP in the first frame indicates an AP allowed of contending for the first transmission opportunity.

In some implementations, the second AP directly indicates the third information in the User Information field in the first frame. That is, the User Information field in the first frame is used to indicate one or more APs disallowed of contending for the first transmission opportunity. Exemplarily, the User Information field in the first frame includes a User Information field corresponding to the third AP and a User Information field corresponding to an AP other than the third AP. A User Information field corresponding to each other AP in the first frame indicates an AP disallowed of contending for the first transmission opportunity.

In some implementations, the second AP indicates, in the User Information field in the first frame, whether the AP is allowed of contending for the first transmission opportunity. That is, the User Information field in the first frame is used to indicate whether one or more APs are allowed of contending for the first transmission opportunity. Exemplarily, the User Information field in the first frame includes a User Information field corresponding to the third AP and a User Information field corresponding to an AP other than the third AP. A User Information field corresponding to each other AP in the first frame is used to indicate whether the AP is allowed of contending for the first transmission opportunity. Exemplarily, the User Information field corresponding to each other AP in the first frame includes a field (such as a Transmission Allow field), and the field is used to indicate whether the AP is allowed of contending for the first transmission opportunity.

The manner of indicating the AP is not limited in the embodiments of the present disclosure. Exemplarily, the AP is indicated by one or more of: an associated identifier (AID), a multi-AP set identifier (M-AP set ID), or a coordinate AP identifier (C-AP ID).

For example, the AP is indicated by an AID. For example, the User Information field in the first frame indicates an AID to indicate that an AP corresponding to the AID is allowed of contending for the first transmission opportunity. Alternatively, the User Information field in the first frame indicates an AID to indicate that an AP corresponding to the AID is disallowed of contending for the first transmission opportunity. Alternatively, the User Information field in the first frame indicates an AID to indicate whether an AP corresponding to the AID is allowed of contending for the first transmission opportunity.

For example, the AP is indicated by an AID and an M-AP set ID. For example, the User Information field in the first frame indicates an AID and an M-AP set ID to indicate that an AP corresponding to the AID and the M-AP set ID is allowed of contending for the first transmission opportunity. Alternatively the User Information field in the first frame indicates an AID and an M-AP set ID to indicate that an AP corresponding to the AID and the M-AP set ID is disallowed of contending for the first transmission opportunity. Alternatively, the User Information field in the first frame indicates an AID and an M-AP set ID to indicate whether an AP corresponding to the AID and the M-AP set ID is allowed of contending for the first transmission opportunity.

For example, the AP is indicated by an AID and a C-AP ID. For example, the User Information field in the first frame indicates an AID and a C-AP ID to indicate that an AP corresponding to the AID and the C-AP ID is allowed of contending for the first transmission opportunity. Alternatively, the User Information field in the first frame indicates an AID and a C-AP ID to indicate that an AP corresponding to the AID and the C-AP ID is disallowed of contending for the first transmission opportunity. Alternatively, the User Information field in the first frame indicates an AID and a C-AP ID to indicate whether an AP corresponding to the AID and the C-AP ID is allowed of contending for the first transmission opportunity.

As described above, in some embodiments, the User Information field corresponding to the third AP in the first frame is used to indicate the first information (namely, the transmission duration shared by the second AP with the third AP). In some embodiments, first information indicated by a User Information field corresponding to the third AP is different from first information indicated by a User Information field corresponding to another AP to avoid a case in which the AP fails to determine an AP to which the second AP shares the first transmission opportunity. Using an example where the first information is indicated by the Allocation Duration field in the User Information field, the value of the Allocation Duration field in the User Information field corresponding to the third AP is not 0 (for example, may be a value of the transmission duration shared by the second AP with the third AP), and the value of an Allocation Duration field in a User Information field corresponding to another AP is 0, so as to indicate that the first transmission opportunity (or the transmission duration) is not shared with the another AP.

In some embodiments, the first frame includes indication information indicating a transmission opportunity sharing mode. In some implementations, referring to FIG. 13, the first frame includes a Transmission Opportunity Sharing Mode field, and different values of the field are used to indicate different transmission opportunity sharing modes. For example, in the case where the value of the field is 3, the transmission opportunity sharing mode corresponding to the first frame is a multi-AP share mode.

In some embodiments, in the case where the second AP shares the first transmission opportunity with only the third AP, the first frame includes only one User Information field. For example, the first frame includes only one of: an HE Variant User Info field, an EHT Variant User Info field, an Ultra-High Reliability (UHR) Variant User Info field), or a Special User Info field.

In some embodiments, in the case where the second AP shares the first transmission opportunity with only the third AP, the first frame includes a plurality of (for example, two or more) User Information fields. In this case, the User Information field corresponding to the third AP is different from a User Information field corresponding to another AP other than the third AP. For example, the value of the Allocation Duration field in the User Information field corresponding to the third AP is not 0, and the value of an Allocation Duration field in the User Information field corresponding to the another AP is 0.

In some embodiments, the User Information field in the first frame includes an AID field to indicate an AP corresponding to the User Information field. For example, the second AP shares the first transmission opportunity with only the third AP, and an AID field in a User Information field in the first frame is used to indicate the third AP.

The value range of the AID field in the User Information field is not limited in the embodiments of the present disclosure. Exemplarily, the value of the AID field is a value (for example, a range from 1943 to 2007) in a predefined range, and different AID values represent different APs.

In some embodiments, the second AP allocates an AID value to each of neighboring APs in advance. In some embodiments, the second AP further notifies all neighboring APs of a corresponding relationship between AIDs and MAC addresses.

In some embodiments, the User Information field in the first frame includes an M-AP Set ID field to indicate an identifier of a multi-AP set to which a plurality of APs (such as the first AP, the second AP, and the third AP) belong.

In some embodiments, a central control point (such as the second AP or the first AP) in the multi-AP set allocates an AID value to each of the APs in the multi-AP set in advance. In some embodiments, the central control point in the multi-AP set further notifies each AP in the multi-AP set of a corresponding relationship between AIDs and MAC addresses.

In some embodiments, the User Information field in the first frame includes a C-AP ID field to indicate an identifier of a coordinating AP (such as the second AP or the third AP) shared by the first AP, the second AP, and the third AP, or an identifier of a coordination set to which the first AP, the second AP, and the third AP belong.

In some embodiments, the coordinating AP allocates an AID value to each of coordinated APs in advance. In some embodiments, the coordinating AP also notifies all coordinated APs of a corresponding relationship between AIDs and MAC addresses.

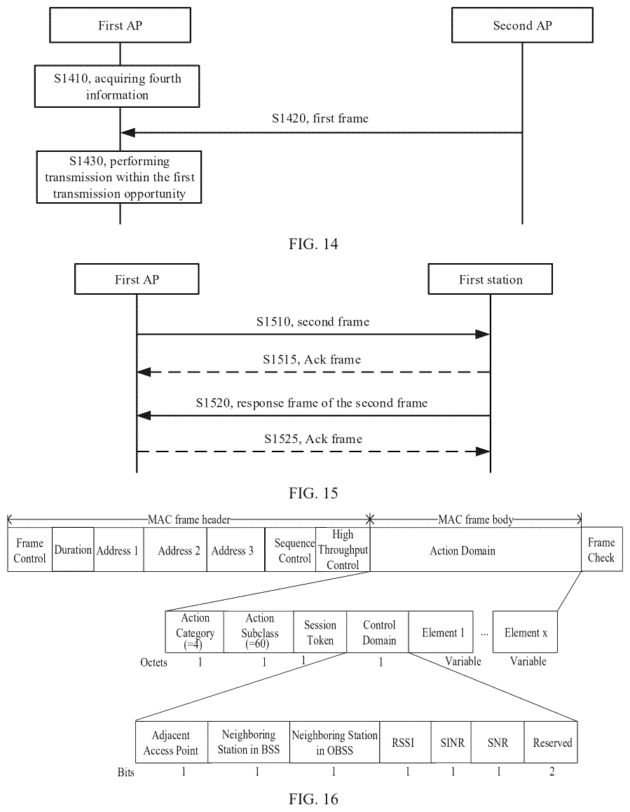

In some embodiments, prior to transmitting using the first transmission opportunity, the first AP determines, based on interference information, whether to perform transmission using the first transmission opportunity, which is described below with reference to FIG. 14.

FIG. 14 is a schematic flowchart of a method for communication according to some embodiments of the present disclosure. The method shown in FIG. 14 includes S1410 to S1430.

In S1410, the first AP acquires fourth information, wherein the fourth information is used to indicate information of a station causing interference to transmission performed by the first AP and/or the third AP.

In some embodiments, the fourth information is used to indicate information of a station associated with the first AP. The station causes interference to transmission performed by the third AP, or the station experiences interference from transmission performed by the third AP. Alternatively, in some embodiments, the fourth information is used to indicate information of a station associated with the third AP. The station causes interference to transmission performed by the first AP, or the station experiences interference from transmission performed by the first AP.

For example, the fourth information is used to indicate information of a station that may experience interference from the transmission performed by the third AP, and the station may be, for example, a station associated with the first AP. Using an example of the application scenario shown in FIG. 11, it is assumed that the first AP is AP 3, the second AP is AP 2, and the third AP is AP 1. Transmission performed by AP 1 may interfere to STA 3A associated with AP 3. In this case, the fourth information is used to indicate information of STA 3A.

For example, the fourth information is used to indicate information of a station causing interference to the transmission performed by the first AP, and the station is, for example, a station associated with the third AP. Using an example of the application scenario shown in FIG. 11, it is assumed that the first AP is AP 4, the second AP is AP 2, and the third AP is AP 1. STA 1A associated with AP 1 may cause interference to the transmission performed by AP 4. In this case, the fourth information is used to indicate information of STA 1A.

In some embodiments, the fourth information includes OBSS information of the first AP. In some embodiments, the information of the station causing interference to the transmission performed by the first AP and/or the third AP is determined based on the OBSS information of the first AP.

In some embodiments, the fourth information includes information (for example, OBSS information) sensed by the first AP. In some embodiments, the fourth information includes information sensed by a station associated with the first AP. In some embodiments, the fourth information includes information sensed by the first AP and information sensed by a station associated with the first AP.

Exemplarily, in some embodiments, the fourth information includes one or more of: information of another AP sensed by the first AP, information of a station associated with the another AP sensed by the first AP, information of the another AP sensed by one or more stations associated with the first AP, or information of another station sensed by the one or more stations associated with the first AP.

In some embodiments, the information of the another station sensed by the one or more stations associated with the first AP includes one or more of: information of another station associated with the first AP sensed by the one or more stations, or information of a station associated with an AP other than the first AP sensed by the one or more stations.

Information in the fourth information is not limited in the embodiments of the present disclosure. Exemplarily, the fourth information includes one or more of: identification information of APs, information of signal received quality of the APs, identification information of stations, or information of signal received quality of the stations.

For example, the information of the another AP sensed by the first AP includes identification information and/or information of signal received quality of the another AP sensed by the first AP. For example, the information of the station associated with the another AP sensed by the first AP includes identification information and/or information of signal received quality of the another station sensed by the first AP. For example, the information of the another AP sensed by the station associated with the first AP includes identification information and/or information of signal received quality of the another AP sensed by the station associated with the first AP. For example, the information of the another station sensed by the station associated with the first AP includes identification information and/or information of signal received quality of the another station sensed by the station associated with the first AP.

A manner of identifying identification information of APs and/or identification information of stations is not limited in the embodiments of the present disclosure. Exemplarily, the identification information of the APs and/or the identification information of the stations is identified by one or more of: a MAC address, an AID, or a non-associated identifier.

A manner of indicating information of signal received quality of APs and/or information of signal received quality of stations is not limited in the embodiments of the present disclosure. Exemplarily, the information of the signal received quality of the APs and/or the information of the signal received quality of the stations are indicated by one or more of: an RSSI, a signal-to-noise ratio (SNR), or a signal to interference plus noise ratio (SINR).

In some embodiments, in addition to the identification information and/or the information of the signal received quality, the information in the fourth information further includes other information, which is not limited in the embodiments of the present disclosure. For example, the fourth information further includes information of a BSS to which a sensed AP or station belongs, for example, identification information of the BSS.

In some embodiments, upon acquiring the fourth information, the first AP stores the fourth information. A manner in which the first AP stores the fourth information is not limited in the embodiments of the present disclosure. In some embodiments, the first AP stores one or more types of the following information in the fourth information: an AID of a sensed AP or station, a MAC address of the sensed AP or station, an identifier of the BSS to which the sensed AP or station belongs, and an RSSI of the sensed AP or station. An example is illustrated hereinafter with reference to Table 1. The example in Table 1 is described using the application scenario shown in FIG. 11 as an example, and the first AP is AP 3.

TABLE 1

| | | BSS ID of the | |
|---|---|---|---|
| | | BSS to which | |
| AID of | MAC of | the sensed | RSSI of |
| the sensed | the sensed | AP/station | the sensed |
| AP/station | AP/station | belongs | AP/station |
| 0 (representing | 001A2B3C4D52 | 001A2B3C4D52 | −60 dBm |
| AP 3) | (representing AP 2) | | |
| 0 | 000C29CAE460 | 001A2B3C4D52 | −65 dBm |
| | (representing STA 2A) | | |
| 1 (representing | 001A2B3C4D52 | 001A2B3C4D52 | −66 dBm |
| STA 3A) | (representing AP 2) | | |
| 1 | 001A2B3C4D51 | 001A2B3C4D51 | −65 dBm |
| | (representing AP 1) | | |
| 1 | 000C29CAE461 | 001A2B3C4D51 | −70 dBm |
| | (representing STA 1C) | | |

An implementation in which the first AP acquires the fourth information is not limited in the embodiments of the present disclosure. In some embodiments, the first AP acquiring the fourth information refers to that the first AP acquires the fourth information by sensing another AP or a station associated with another AP. In some embodiments, the first AP acquiring the fourth information refers to that the first AP acquires the fourth information by requesting a station (for example, the first station) associated with the first AP. A process in which the first AP requests the station associated with the first AP to acquire the fourth information is described in detail below, and details are not described herein.

In S1420, the first AP receives the first frame from the second AP, wherein the first frame is used to indicate the first transmission opportunity shared by the second AP with the third AP.

An order of S1410 and S1420 is not limited in the embodiments of the present disclosure. Exemplarily, S1410 is performed prior to S1420, or is performed upon S1420, or is performed simultaneously with S1420.

For related descriptions of S1420, reference may be made to the foregoing descriptions of S1210. For brevity, details are not repeated herein.

In S1430, the first AP performs transmission within the first transmission opportunity.

For related descriptions of S1430, reference may be made to the foregoing descriptions of S1220. For brevity, details are not repeated herein.

As mentioned above, the first AP requests the station associated with the first AP to acquire the fourth information. The process in which the first AP requests the station associated with the first AP to acquire the fourth information is described hereinafter with reference to FIG. 15.

FIG. 15 is a schematic flowchart of acquiring fourth information according to some embodiments of the present disclosure. The method shown in FIG. 15 includes S1510 and S1520.

In S1510, the first AP transmits a second frame to the first station, wherein the second frame is used to request to acquire the fourth information.

The first station is any station associated with the first AP. For example, using an example where the first AP is AP 3 shown in FIG. 11, the first station is also STA 3A or STA 3B.

In some embodiments, in the case where the fourth information includes the OBSS information of the first AP, the second frame is also referred to as or understood as an OBSS information request frame.

A manner in which the first AP transmits the second frame is not limited in the embodiments of the present disclosure. In some embodiments, the second frame is transmitted by the first AP to the first station in a unicast manner. In some embodiments, the second frame is transmitted by the first AP to the first station in a multicast manner. For example, the first AP transmits the second frame to all stations associated with the first AP in a multicast manner.

Information in the second frame is not limited in the embodiments of the present disclosure. An example of a possible implementation of the second frame is illustrated with reference to FIG. 16.

As shown in FIG. 16, in some embodiments, the second frame is a public action frame.

In some embodiments, the second frame includes a Control Domain field. For example, an Action Domain field in the second frame includes a Control Domain field. In some embodiments, the Control Domain field of the second frame includes a plurality of bits, and the plurality of bits are used to indicate different pieces of information. Exemplarily, the plurality of bits in the Control Domain field of the second frame are used to indicate one or more: information indicating whether to request a peer terminal (receiver) to report information of a neighboring AP, information indicating whether to request the peer terminal to report information of a neighboring station in a BSS in which the first AP is located, information indicating whether to request the peer terminal to report information of a neighboring station in an OBSS, information indicating whether the information requested to be reported by the peer terminal includes information of signal received quality, and the like. For example, the information of the signal received quality indicated by the plurality of bits in the Control Domain field of the second frame includes one or more of: information indicating whether the information requested to be reported by the peer terminal includes an RSSI, information indicating whether the information requested to be reported by the peer terminal includes an SINR, information indicating whether the information requested to be reported by the peer terminal includes an SNR, and the like.

In S1520, the first station transmits a response frame of the second frame to the first AP.

In some embodiments, the response frame includes the fourth information. For example, the response frame includes information of another AP sensed by the first station and/or information of another station sensed by the first station.

In some embodiments, in the case where the fourth information includes the OBSS information of the first AP, and the response frame of the second frame is also referred to as or understood as an OBSS information response frame.

In some embodiments, the response frame of the second frame is transmitted by the first station to the first AP in a unicast manner.

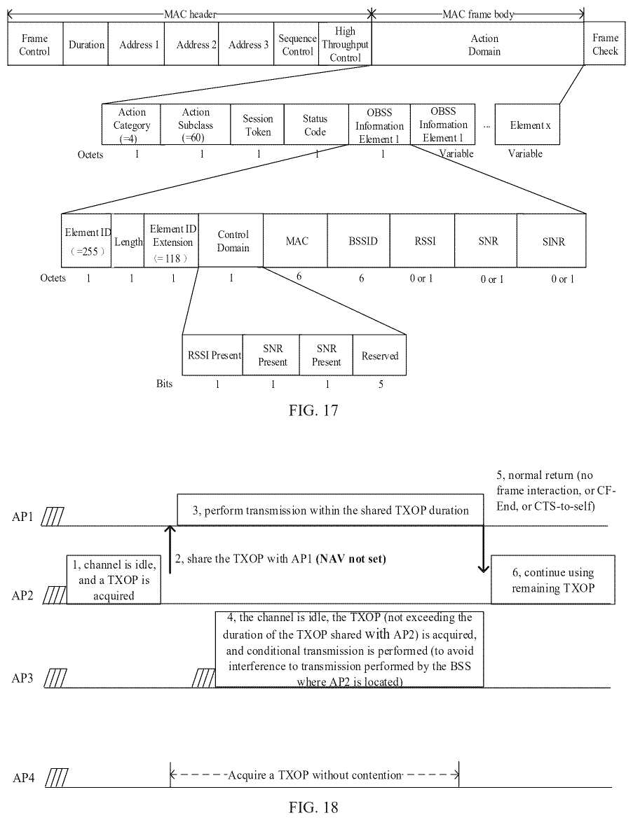

Information in the response frame of the second frame is not limited in the embodiments of the present disclosure. An example of a possible implementation of the response frame of the second frame is illustrated hereinafter with reference to FIG. 17.

As shown in FIG. 17, in some embodiments, the response frame of the second frame is a public action frame.

In some embodiments, the response frame of the second frame includes a Status Code field.

In some embodiments, the response frame of the second frame includes one or more OBSS information elements.

In some embodiments, in the case where a Status Code field in the response frame of the second frame indicates a success, the response frame of the second frame includes one or more OBSS information elements. In some embodiments, in the case where the Status Code field in the response frame of the second frame indicates a failure, the response frame of the second frame does not include an OBSS information element.

In some embodiments, the response frame of the second frame includes a Control Domain field. For example, an OBSS Information Element field in the response frame of the second frame includes a Control Domain field. In some embodiments, the Control Domain field of the response frame of the second frame is used to indicate whether information reported by the first station includes information of signal received quality.

In some embodiments, the Control Domain field of the response frame of the second frame includes a plurality of bits, and the plurality of bits are used to indicate different pieces of information. Exemplarily, the plurality of bits in the Control Domain field of the response frame are used to indicate one or more of: information indicating whether reported information includes an RSSI, information indicating whether reported information includes an SINR, information indicating whether reported information includes an SNR, and the like.

In some embodiments, an OBSS information element in the response frame of the second frame includes a MAC field, and the MAC field is used to indicate MAC address information of an AP and/or a station sensed by the first station.

In some embodiments, an OBSS information element in the response frame of the second frame includes a BSS ID field, and the BSS ID field is used to indicate a BSS ID of a BSS to which an AP and/or a station sensed by the first station belongs.

In some embodiments, an OBSS information element in the response frame of the second frame includes one or more of an RSSI field, an SNR field, or an SINR field. The RSSI field is used to indicate an RSSI of a PPDU of an AP or a station received by the first station, the SNR field is used to indicate an SNR of the PPDU of the AP or the station received by the first station, and the SINR field is used to indicate an SINR of the PPDU of the AP or the station received by the first station.

In some embodiments, the first AP periodically or aperiodically repeats the process of acquiring the fourth information shown in FIG. 15 to update the fourth information.

In some embodiments, the first AP acquires the fourth information by a procedure of acquiring OBSS information in the case where a plurality of APs perform coordinated measurement in a C-SR mechanism. That is, in some embodiments, a process in which the first AP acquires the fourth information from the first station is a process in which a coordinating AP coordinates measurement of a plurality of APs, and stations associated with the plurality of APs report measurement results. Exemplarily, for a process in which the first AP acquires the fourth information from the first station, reference may be made to the foregoing process of acquiring the OBSS information shown in FIG. 7.

The coordinating AP is not limited in the embodiments of the application. In some embodiments, the coordinating AP is a second AP (i.e., a sharing AP). In some embodiments, the coordinating AP is a first AP (i.e., an AP contending for a first transmission opportunity). In some embodiments, the coordinating AP is a third AP (that is, a shared AP). In some embodiments, the coordinating AP is alternatively an AP other than the first AP, the second AP, and the third AP.

In some embodiments, the measurement results reported by the stations associated with the plurality of APs carry the fourth information, for example, information of an AP and/or a station sensed by the first station.

In some embodiments, during interaction between the first AP and the first station, upon receiving a frame from a transmitter, the peer terminal transmits an Ack frame as a response to the transmitting end to indicate that the peer terminal correctly receives the frame from the transmitter. Exemplarily, referring to FIG. 15, in some embodiments, the method shown in FIG. 15 further includes S1515 and S1525.

In S1515, the first station transmits an Ack frame to the first AP to indicate that the first station correctly receives the second frame from the first AP.

In S1525, the first AP transmits an Ack frame to the first station to indicate that the first AP correctly receives the response frame of the second frame from the first station.

A transmission process between a plurality of APs in the embodiments of the present disclosure is illustrated hereinafter.

As shown in FIG. 18, after the second AP successfully shares the first transmission opportunity with the third AP, the third AP performs transmission within transmission duration shared by the second AP. Meanwhile, the first AP also performs transmission within the transmission duration shared by the second AP with the third AP. Typically, in the transmission duration successfully shared by the second AP with the third AP, the third AP performs transmission with a station associated with the third AP until the shared transmission duration terminates. Then, the second AP performs transmission within a remaining duration of the first transmission opportunity after the shared transmission duration terminates for a period of time (for example, a priority interframe space (PIFS)). In this case, the first transmission opportunity is normally returned to the second AP, or the second AP normally gets control of the first transmission opportunity.

In some embodiments, transmission between the third AP and a station associated with the third AP terminates in advance, or transmission between the third AP and a station associated with the third AP terminates prior to expiration of the transmission duration shared by the second AP with the third AP. In this case, the third AP transmits an indication frame (for example, a CF-End frame) to the second AP to indicate that the first transmission opportunity is returned to the second AP in advance.

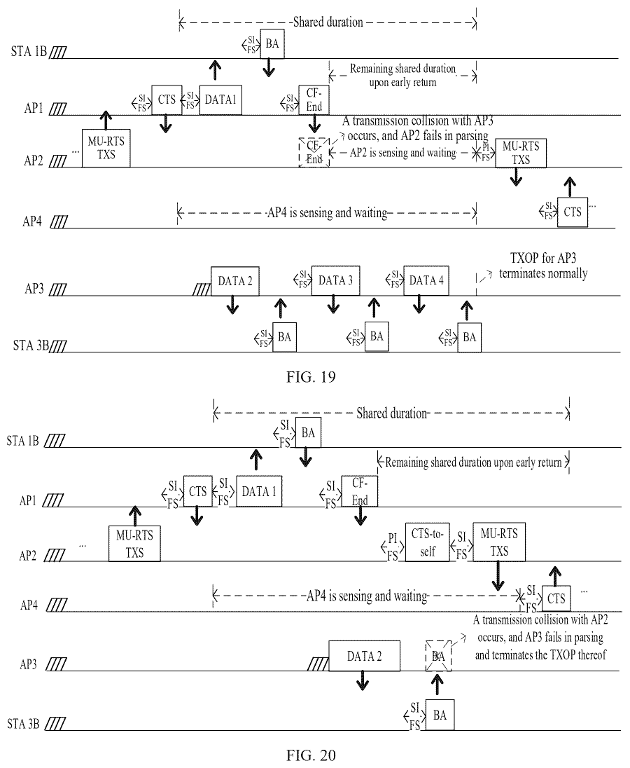

In some embodiments, after the third AP transmits the indication frame to the second AP, the second AP fails to receive the indication frame from the third AP. For example, transmission between the first AP and the station associated therewith causes interference to reception, by the second AP, of the indication frame from the third AP. Consequently, the second AP fails to receive the indication frame from the third AP. In this case, as shown in FIG. 19, the second AP needs to wait until the transmission duration shared by the second AP with the third AP expires, and then normally performs transmission within the remaining duration of the first transmission opportunity acquired by the second AP.

In some embodiments, after the third AP transmits the indication frame to the second AP, the second AP successfully receives the indication frame from the third AP. Then, the second AP transmits a third frame to the first AP to indicate that the first AP terminates the transmission performed by the first AP.

An implementation of the third frame is not limited in the embodiments of the present disclosure. In some embodiments, the third frame is, for example, a CTS-to-self frame. In some embodiments, the third frame is a frame other than the CTS-to-self frame. For example, the third frame is an RTS frame to request the first AP to terminate the transmission performed by the first AP.

In some embodiments, upon receiving the indication frame from the third AP, the second AP transmits the third frame upon waiting for a period of time (for example, a PIFS). However, the embodiments of the present disclosure are not limited thereto. For example, upon receiving the indication frame from the third AP, the second AP immediately transmits the third frame.

In some embodiments, upon receiving the third frame from the second AP, the first AP terminates (or terminates) the transmission performed by the first AP as soon as possible to ensure that the second AP gets control of the first transmission opportunity as soon as possible.

In some embodiments, in the case where the first AP detects at least one transmission collision or a busy channel within the first transmission opportunity, the first AP terminates the transmission performed by the first AP. For example, in the case where the first AP detects any transmission collision or busy channel in the first transmission opportunity, the first AP terminates the transmission performed by the first AP. In this way, the second AP backer-acquires the control of the first transmission opportunity as soon as possible.

In some embodiments, after the second AP transmits the third frame to the first AP, a plurality of cases may occur. However, in any of the cases, the first AP terminates the transmission performed by the first AP as soon as possible, such that the second AP gets the control of the first transmission opportunity as soon as possible. Examples of possible cases upon transmission, by the second AP, of the third frame to the first AP are illustrated hereinafter with reference to FIGS. 20 to 22.

As shown in FIG. 20, after the second AP transmits the third frame to the first AP, the first AP is waiting for uplink transmission performed by a station associated with the first AP. In this case, in the case where the first AP detects any transmission collision or busy channel within the first transmission opportunity, the first AP terminates the transmission performed by the first AP to terminate the transmission performed by the first AP as soon as possible.

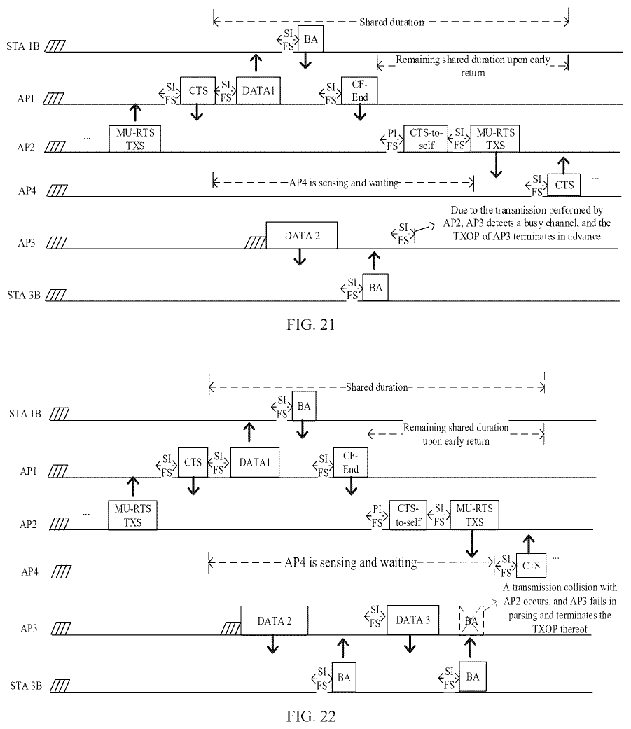

As shown in FIG. 21, after the second AP transmits the third frame to the first AP, the first AP is in an SIFS to prepare for downlink transmission. In this case, in the case where the first AP detects any transmission collision or busy channel within the first transmission opportunity, the first AP terminates the transmission performed by the first AP to terminate the transmission performed by the first AP as soon as possible.

As shown in FIG. 22, upon the second AP transmits the third frame to the first AP, the first AP starts downlink transmission at the same time. In this case, in the case where the first AP detects any transmission collision or busy channel within the first transmission opportunity, the first AP terminates the transmission performed by the first AP to terminate the transmission performed by the first AP as soon as possible.

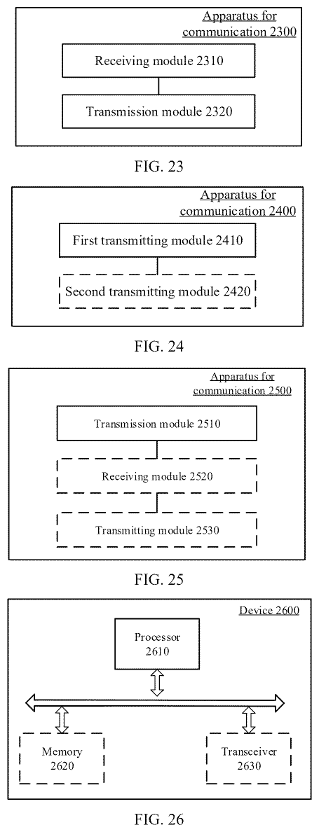

The method embodiments of the present disclosure are described in detail above with reference to FIGS. 1 to 22, and apparatus embodiments of the present disclosure are described in detail below with reference to FIGS. 23 to 26. It should be understood that the description of the method embodiments corresponds to the description of the apparatus embodiments, and therefore reference may be made to the method embodiments above for parts that are not described in detail.

FIG. 23 is a schematic structural diagram of an apparatus for communication according to some embodiments of the present disclosure. The apparatus 2300 for communication shown in FIG. 23 is any first AP described above. The apparatus 2300 for communication includes a receiving module 2310 and a transmission module 2320.

The receiving module 2310 is configured to receive a first frame from a second AP, wherein the first frame is used for the second AP to share a first transmission opportunity with a third AP; and
the transmission module 2320 is configured to perform transmission within the first transmission opportunity.

In some embodiments, the transmission module is configured to perform the transmission within the first transmission opportunity in a case where a first condition is satisfied, wherein the first condition is associated with one or more of: information indicating whether transmission performed by the first AP affects transmission performed by the second AP and/or the third AP; information indicating whether transmission performed by the second AP and/or the third AP affects transmission performed by the first AP; or information indicating whether transmission performed by the first AP affects control by the second AP over the first transmission opportunity.

In some embodiments, the first condition comprises one or more of following items: transmission between the first AP and a first station does not affect the transmission performed by the second AP; transmission between the first AP and a first station does not affect the transmission performed by the third AP; transmission between the second AP and a station associated with the second AP does not affect transmission between the first AP and a first station; transmission between the third AP and a station associated with the third AP does not affect transmission between the first AP and a first station; or transmission between the first AP and a first station does not affect the control by the second AP over the first transmission opportunity; wherein the first station is a station associated with the first AP.

In some embodiments, the transmission module is configured to perform the transmission within the first transmission opportunity in a case where the second AP successfully shares the first transmission opportunity with the third AP.

In some embodiments, the first transmission opportunity is successfully shared based on one or more of following items: the first AP detects that a channel shared by the first AP and the second AP is idle within a first duration; or the first AP detects, after a period of time since receipt of the first frame, that a channel shared by the first AP and the second AP is idle within a first duration; wherein the first duration is used to indicate a duration required by the third AP to respond to the first frame.

In some embodiments, the first duration is related to one or more of: a duration of a CTS frame, a short interframe space, or a duration of a slot.

In some embodiments, the apparatus for communication further comprises a first contending module, configured to contend for a second transmission opportunity, wherein the second transmission opportunity is located within the first transmission opportunity.

In some embodiments, the second transmission opportunity is acquired by one or more of: contention using an enhanced distributed channel access mechanism; contention using an OBSS packet detect-based spatial reuse mechanism; contention upon exclusion of stations, from one or more stations associated with the first AP, which are in collision with transmission performed by the second AP and/or the third AP; or contention in a case where transmission between the third AP and a second station associated with the third AP is not performed, wherein transmission performed by the first AP affects the transmission between the third AP and the second station, or the transmission between the third AP and the second station affects transmission performed by the first AP.

In some embodiments, the apparatus for communication further comprises a second contending module, configured to refrain from contending for a second transmission opportunity in a case where transmission performed by the first AP affects transmission between the third AP and a station associated with the third AP, wherein the second transmission opportunity is located within the first transmission opportunity.

In some embodiments, the apparatus for communication further comprises a responding module, configured to refrain from responding to contention of the first station in a case where the first station associated with the first AP contends for the first transmission opportunity.

In some embodiments, the first frame comprises first information, wherein the first information is used to indicate a transmission duration shared by the second AP with the third AP, and the first information is indicated by a User Information field corresponding to the third AP.

In some embodiments, the first frame comprises one or more of: second information, used to indicate one or more APs allowed of contending for the first transmission opportunity; or third information, used to indicate one or more APs disallowed of contending for the first transmission opportunity.

In some embodiments, the second information and/or the third information is indicated by a User Information field of the first frame.

In some embodiments, the first frame is broadcast by the first AP.

In some embodiments, the apparatus for communication further comprises an acquiring module, configured to acquire fourth information, wherein the fourth information is used to indicate information of a station causing interference to transmission performed by the first AP and/or the third AP.

In some embodiments, the fourth information comprises OBSS information of the first AP.

In some embodiments, the fourth information comprises one or more of: information of another AP sensed by the first AP; information of a station associated with another AP and sensed by the first AP; information of another AP sensed by one or more stations associated with the first AP; or information of another station sensed by one or more stations associated with the first AP.

In some embodiments, the fourth information comprises one or more of: identification information of an AP; information of signal received quality of an AP; identification information of a station; or information of signal received quality of a station.

In some embodiments, the acquiring module is configured to: transmit a second frame to a first station, wherein the second frame is used to request the fourth information; and receive a response frame of the second frame from the first station, wherein the response frame comprises the fourth information, wherein the first station is a station associated with the first AP.

In some embodiments, the apparatus for communication further comprises: a receiving module, configured to receive a third frame from the second AP, wherein the third frame is used to indicate that the first AP terminates transmission performed by the first AP; and a terminating module, configured to terminate the transmission performed by the first AP in a case where the first AP detects at least one transmission collision or a busy channel within the first transmission opportunity.

FIG. 24 is a schematic structural diagram of an apparatus for communication according to some embodiments of the present disclosure. The apparatus 2400 for communication shown in FIG. 24 is any second AP described above. The apparatus 2400 for communication includes a first transmitting module 2410.

The first transmitting module 2410 is configured to transmit a first frame to a first AP, wherein the first frame is used for the second AP to share a first transmission opportunity with a third AP, wherein the first transmission opportunity is used for transmission between the third AP and the first AP.

In some embodiments, in a case where a first condition is satisfied, the first transmission opportunity is used for the first AP to perform transmission, information indicating wherein the first condition is associated with one or more of: information indicating whether transmission performed by the first AP affects transmission performed by the second AP and/or the third AP; information indicating whether transmission performed by the second AP and/or the third AP affects transmission performed by the first AP; or information indicating whether transmission performed by the first AP affects control by the second AP over the first transmission opportunity.

In some embodiments, the first condition comprises one or more of following items: transmission between the first AP and a first station does not affect the transmission performed by the second AP; transmission between the first AP and a first station does not affect the transmission performed by the third AP; transmission between the second AP and a station associated with the second AP does not affect transmission between the first AP and a first station; transmission between the third AP and a station associated with the third AP does not affect transmission between the first AP and a first station; or transmission between the first AP and a first station does not affect the control by the second AP over the first transmission opportunity; wherein the first station is a station associated with the first AP.

In some embodiments, transmission performed by the first AP within the first transmission opportunity is performed in a case where the second AP successfully shares the first transmission opportunity with the third AP.

In some embodiments, the first transmission opportunity is successfully shared based on one or more of following items: the first AP detects that a channel shared by the first AP and the second AP is idle within a first duration; or the first AP detects, after a period of time since receipt of the first frame, that the channel shared by the first AP and the second AP is idle within a first duration; wherein the first duration is used to indicate a duration required by the third AP to respond to the first frame.

In some embodiments, the first duration is related to one or more of: a duration of a clear-to-send (CTS) frame, a short interframe space, or a duration of a slot.

In some embodiments, the first frame comprises first information, wherein the first information is used to indicate a transmission duration shared by the second AP with the third AP, and the first information is indicated by a User Information field corresponding to the third AP.

In some embodiments, the first frame comprises one or more of: second information, used to indicate one or more APs allowed of contending for the first transmission opportunity; or third information, used to indicate one or more APs disallowed of contending for the first transmission opportunity.

In some embodiments, at least one of the second information or the third information is indicated by a User Information field of the first frame.

In some embodiments, the first frame is broadcast by the first AP.

In some embodiments, the apparatus for communication further comprises a second transmitting module, configured to transmit a third frame to the first AP, wherein the third frame is used to indicate that the first AP terminates transmission performed by the first AP, wherein the transmission performed by the first AP is terminated in a case where the first AP detects at least one transmission collision or a busy channel within the first transmission opportunity.

FIG. 25 is a schematic structural diagram of an apparatus for communication according to some embodiments of the present disclosure. The apparatus 2500 for communication shown in FIG. 25 is any first AP described above. The apparatus 2500 for communication includes a transmission module 2510.

The transmission module 2510 is configured to perform transmission with a first AP within a first transmission opportunity, wherein the first station is a station associated with the first AP, and the first transmission opportunity is acquired by the first AP from a first frame transmitted by a second AP, wherein the first frame is used for the second AP to share the first transmission opportunity with a third AP.

In some embodiments, the transmission module is configured to: perform the transmission with the first AP within the first transmission opportunity in a case where a first condition is satisfied, wherein the first condition is associated with one or more of: information indicating whether transmission performed by the first AP affects transmission performed by the second AP and/or the third AP; information indicating whether transmission performed by the second AP and/or the third AP affects transmission performed by the first AP; or information indicating whether transmission performed by the first AP affects control by the second AP over the first transmission opportunity.

In some embodiments, the first condition comprises one or more of following items: transmission between the first AP and the first station does not affect the transmission performed by the second AP; the transmission between the first AP and the first station does not affect the transmission performed by the third AP; transmission between the second AP and a station associated with the second AP does not affect transmission between the first AP and the first station; transmission between the third AP and a station associated with the third AP does not affect transmission between the first AP and the first station; or transmission between the first AP and the first station does not affect the control by the second AP over the first transmission opportunity.

In some embodiments, the transmission module is configured to perform the transmission with the first AP within the first transmission opportunity in a case where the second AP successfully shares the first transmission opportunity with the third AP.

In some embodiments, the first transmission opportunity is successfully shared based on one or more of following items: the first AP detects that a channel shared by the first AP and the second AP is idle within a first duration; or the first AP detects, after a period of time since receipt of the first frame, that a channel shared by the first AP and the second AP is idle within a first duration; wherein the first duration is used to indicate a duration required by the third AP to respond to the first frame.

In some embodiments, the first duration is related to one or more of: a duration of a CTS frame, a short interframe space, or a duration of a slot.

In some embodiments, the first frame comprises first information, wherein the first information is used to indicate a transmission duration shared by the second AP with the third AP, and the first information is indicated by a User Information field corresponding to the third AP.

In some embodiments, the first frame comprises one or more: second information, used to indicate one or more APs allowed of contending for the first transmission opportunity; or third information, used to indicate one or more APs disallowed of contending for the first transmission opportunity.

In some embodiments, at least one of the second information or the third information is indicated by a User Information field of the first frame.

In some embodiments, the first frame is broadcast by the first AP.

In some embodiments, the apparatus for communication further comprises a receiving module 2520, configured to receive a second frame from the first AP, wherein the second frame is used to request fourth information; and a transmitting 2530 module, configured to transmit a response frame of the second frame to the first AP, wherein the response frame comprises the fourth information, wherein the fourth information is used to indicate information of a station causing interference to transmission performed by the first AP and/or the third AP.

In some embodiments, the fourth information comprises OBSS information of the first AP.

In some embodiments, the fourth information comprises one or more of: information of another AP sensed by the first AP; information of a station associated with another AP sensed by the first AP; information of another AP sensed by one or more stations associated with the first AP; or information of another station sensed by one or more stations associated with the first AP.

In some embodiments, the fourth information comprises one or more of: identification information an AP; information of signal received quality of an AP; identification information of a station; and information of signal received quality of a station.

In some embodiments, transmission between the first station and the first AP is terminated in a case where the first AP detects at least one transmission collision or a busy channel within the first transmission opportunity.

FIG. 26 is a schematic structural diagram of a communication device according to some embodiments of the present disclosure. A dashed line in FIG. 26 indicates that a corresponding unit or module is optional. The device 2600 may be configured to perform the method for communication described in the above method embodiments. The device 2600 may be a chip, a terminal device, or a network device.

The device 2600 may include at least one processor 2610. The processor 2610 may support the device 2600 to perform the method described in the above method embodiments. The processor 2610 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The device 2600 may further include at least one memory 2620. The memory 2620 stores one or more programs. The one or more programs are performed by the processor 2610, such that the processor 2610 performs the method described in the above method embodiments. The memory 2620 may be independent of the processor 2610 or integrated in the processor 2610.

The device 2600 may also include a transceiver 2630. The processor 2610 communicates with another device or chip over the transceiver 2630. For example, the processor 2610 performs data transmission or data reception with the another device or chip over the transceiver 2630.

The embodiments of the present disclosure further provide a computer-readable storage medium configured to store one or more programs. The computer-readable storage medium is applicable to a terminal or a network device according to the embodiments of the present disclosure, and the one or more programs, when loaded and run, cause a computer to perform the method for communication performed by the terminal or the network device in the embodiments of the present disclosure.

The embodiments of the present disclosure further provide a computer program product. The computer program product includes one or more programs. The computer program product is applicable to a terminal or a network device according to the embodiments of the present disclosure, and the one or more programs, when loaded and run, cause a computer to perform the method for communication performed by the terminal or the network device in the embodiments of the present disclosure.

The embodiments of the present disclosure further provide a computer program. The computer program is applicable to a terminal or a network device according to the embodiments of the present disclosure, and the computer program, when loaded and run, cause a computer to perform the method for communication performed by the terminal or the network device in the embodiments of the present disclosure.

It should be understood that the terms “system” and “network” are interchangeably used in the present disclosure. The terms used in the embodiments of the present disclosure are used only to illustrate the specific embodiments of the present disclosure, and are not intended to limit the present disclosure. The terms “first,” “second,” “third,” “fourth,” or the like in the description, claims and the accompanying drawings of the present disclosure are intended to distinguish between different objects but do not indicate a specific sequence. Moreover, the terms “include,” “have,” and any variations thereof are intended to cover non-exclusive inclusion.

It should be understood that the term “indication” mentioned in the embodiments of the present disclosure may be a direct indication, an indirect indication, or an association relationship. For example, A indicates B, which may mean that A directly indicates B, for example, B can be acquired using A; may mean that A indirectly indicates B, for example, A indicates C, wherein B can be acquired using C; or may mean an association relationship between A and B.

It should be understood that in the embodiments of the present disclosure, “B corresponding to A” means that B is associated with A, and B may be determined based on A. It should also be understood that determining B based on A means that B not only may be determined only based on A, and but also may be determined based on A and/or other information.

In the description of the embodiments of the present disclosure, the term “corresponding” may indicate a direct corresponding relationship or indirect corresponding relationship between two objects, or indicate an association relationship between two objects, or indicate relationships such as indicating and being indicated, configuring and being configured, or the like.

In the embodiments of the present disclosure, “predefinition” may be implemented by pre-storing corresponding code or a corresponding table in a device (such as the terminal device or the network device) or using another method that can be used to indicate relevant information, and a specific implementation method thereof is not limited in the present disclosure. For example, the term “predefined” refers to “defined in protocols.”

In the embodiments of the present disclosure, the “protocols” may be standard protocols in the communication field, for example, the protocols may include an LTE protocol, an NR protocol, or a related protocol applied in a future communication system, which is not limited in the present disclosure.

The term “and/or” in the present disclosure merely describes an association relationship between associated objects, that is, three types of relationships. For example, the phrase “A and/or B” indicates (A), (B), or (A and B). In addition, the character “/” generally indicates an “or” relationship between the associated objects.

In the embodiments of the present disclosure, the term “including/comprising” may be direct or indirect inclusion. In some embodiments, the term “including/comprising” mentioned in the embodiments of the present disclosure can be replaced with “indicating” or “used for determining.” For example, that A includes B may be replaced with that A indicates B or A is used to determine B.

It should be understood that in various embodiments of the application, sequence numbers of the foregoing processes do not imply the order of execution. The order of performing the processes should be determined based on their functions and internal logic, and should not constitute any limitation to the implementation process of the embodiments of the application.

In several embodiments provided in the present disclosure, it should be understood that the disclosed systems, apparatuses, and methods may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions in the embodiments.

In addition, functional units in the embodiments of the present disclosure may be integrated into one processing unit, each of the units may exist alone physically, or two or more units are integrated into one unit.

Some or all of the functions in the foregoing embodiments may be implemented by software, hardware, firmware, or any combination thereof. In a case where software is used for implementation, the implementation can be performed in a form of a computer program product in whole or in part. The computer program product includes one or more computer instructions. When the computer program instructions are loaded and run on a computer, the procedures or functions according to the embodiments of the present disclosure are achieved in whole or in part. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave) manner. The computer-readable storage medium may be any usable medium accessible by a computer, or a data storage device such as a server or a data center, integrating one or more usable media. The usable medium may be a magnetic medium (for example, a floppy disk, a hard disk, or a magnetic tape), an optical medium (for example, a digital video disc (DVD), a semiconductor medium (for example, a solid state disk (SSD)), or the like.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure should be subject to the protection scope of the claims.

1. A method for communication, comprising:
receiving, by a third access point (AP), a first frame from a second AP, wherein the first frame is used for the second AP to share a first transmission opportunity with the third AP, and the first frame is a request-to-send (RTS) frame or a multi-users request-to-send (MU-RTS) trigger frame; and
performing, by the third AP, transmission within the first transmission opportunity.

2. The method according to claim 1, wherein the first frame comprises a Transmission Opportunity Sharing Mode field indicating a transmission opportunity sharing mode, wherein different values of the Transmission Opportunity Sharing Mode field are used to indicate different transmission opportunity sharing modes.

3. The method according to claim 2, wherein the Transmission Opportunity Sharing Mode field indicates that the transmission opportunity sharing mode corresponding to the first frame is a multi-AP share mode when the value of the Transmission Opportunity Sharing Mode field equals to a predefined value.

4. The method according to claim 1, wherein a User Information field in the first frame includes an associated identifier (AID) field to indicate an AP corresponding to the User Information field.

5. The method according to claim 4, wherein the corresponding AP is a third AP indicated by the AID field with which the second AP shares the first transmission opportunity.

6. The method according to claim 4, comprising:
allocating, by the second AP, an AID value to each of APs in a multi-AP set or each of coordinated APs in advance.

7. The method according to claim 1, wherein the first frame comprises first information, wherein the first information is used to indicate a transmission duration shared by the second AP with the third AP, and the first information is indicated by a User Information field corresponding to the third AP.

8. A communication device, wherein the communication device is a third access point (AP), and comprises a memory and a processor, wherein the memory is configured to store one or more programs, and the processor is configured to call the one or more programs in the memory to cause the communication device to:
receive a first frame from a second AP, wherein the first frame is used for the second AP to share a first transmission opportunity with the third AP, and the first frame is a request-to-send (RTS) frame or a multi-users request-to-send (MU-RTS) trigger frame; and
perform transmission within the first transmission opportunity.

9. The communication device according to claim 8, wherein the first frame comprises a Transmission Opportunity Sharing Mode field indicating a transmission opportunity sharing mode, wherein different values of the Transmission Opportunity Sharing Mode field are used to indicate different transmission opportunity sharing modes.

10. The communication device according to claim 9, wherein the Transmission Opportunity Sharing Mode field indicates that the transmission opportunity sharing mode corresponding to the first frame is a multi-AP share mode when the value of the Transmission Opportunity Sharing Mode field equals to a predefined value.

11. The communication device according to claim 8, wherein a User Information field in the first frame includes an associated identifier (AID) field to indicate an AP corresponding to the User Information field.

12. The communication device according to claim 11, wherein the corresponding AP is a third AP indicated by the AID field with which the second AP shares the first transmission opportunity.

13. The communication device according to claim 8, wherein the first frame comprises first information, wherein the first information is used to indicate a transmission duration shared by the second AP with the third AP, and the first information is indicated by a User Information field corresponding to the third AP.

14. A communication device, wherein the communication device is a second access point (AP), and comprises a memory and a processor, wherein the memory is configured to store one or more programs, and the processor is configured to call the one or more programs in the memory to cause the communication device to:
transmit a first frame to a third AP, wherein the first frame is used for the second AP to share a first transmission opportunity with the third AP, and the first frame is an RTS frame or a multi-users MU-RTS trigger frame, wherein the first transmission opportunity is used for transmission between the third AP and the second AP.

15. The communication device according to claim 14, wherein the first frame comprises a Transmission Opportunity Sharing Mode field indicating a transmission opportunity sharing mode, wherein different values of the Transmission Opportunity Sharing Mode field are used to indicate different transmission opportunity sharing modes.

16. The communication device according to claim 15, wherein the Transmission Opportunity Sharing Mode field indicates that the transmission opportunity sharing mode corresponding to the first frame is a multi-AP share mode when the value of the Transmission Opportunity Sharing Mode field equals to a predefined value.

17. The communication device according to claim 14, wherein a User Information field in the first frame includes an associated identifier (AID) field to indicate an AP corresponding to the User Information field.

18. The communication device according to claim 17, wherein the corresponding AP is a third AP indicated by the AID field with which the second AP shares the first transmission opportunity.

19. The communication device according to claim 17, wherein the processor is configured to call the one or more programs in the memory to cause the communication device to:
allocate an AID value to each of APs in a multi-AP set or each of coordinated APs in advance.

20. The communication device according to claim 14, wherein the first frame comprises first information, wherein the first information is used to indicate a transmission duration shared by the second AP with the third AP, and the first information is indicated by a User Information field corresponding to the third AP.
